(19) United States
(12) Patent Application Publication
(10) Pub. No.: US 2010/0055492 A1
(43) Pub. Date: Mar. 4, 2010

(54) MAX-BASED METAL MATRIX COMPOSITES

(75) Inventors: Michel W. Barsoum, Moorestown, NJ (US); Shahram Amini, Plymouth Meeting, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: DREXEL UNIVERSITY, Philadelphia, PA (US)

(21) Appl. No.: 12/477,825

(22) Filed: Jun. 3, 2009

Related U.S. Application Data
(60) Provisional application No. 61/058,513, filed on Jun. 3, 2008.

(51) Int. Cl. B32B 5/18; B32B 15/01; B22D 19/14; C22F 1/06; C22F 1/047

(52) U.S. Cl. 428/613; 428/544; 164/98; 148/527; 148/535; 164/76.1

(57) ABSTRACT

Disclosed are compositions comprising a MAX phase material having the formula Mₙ₊₁AXₙ, wherein M is an early transition metal, A is an A-group element, X one or both of C and N, and n=1-3, wherein the MAX phase material defines a plurality of pores; and, a metal component comprising a low melting point metal, wherein the metal occupies at least some of the pores. Also disclosed are method comprising providing a porous green body comprising a particulate material having the formula Mₙ₊₁AXₙ, wherein M is an early transition metal, A is an A-group element, X one or both of C and N, and n=1-3; and, infiltrating at least some of the pores of the green body with a low melting point metal, thereby providing a composite material.

### CROSS-REFERENCE TO RELATED APPLICATIONS

The present application claims priority to U.S. Provisional Patent Application No. 61/058,513, filed Jun. 3, 2008, the contents of which are hereby incorporated by reference in their entirety.

### GOVERNMENT RIGHTS

The United States government may have rights in the invention described herein, which was made in part with funding from the National Science Foundation (NSF), Grant No. DMRNSF 0736218, and the Army Research Office (ARO) (DAAD19-03-1-0213).

### TECHNICAL FIELD

The present invention relates to composite materials based on MAX-phase compounds, products containing such composites, and methods for producing composite materials.

### BACKGROUND

MAX-phase materials represent a class of solid compositions and are traditionally represented as Mₙ₊₁AXₙ, where M is an early transition metal, A is an A-group element (mostly IIIA and IVA) and X is C and/or N and n=1 to 3. These phase materials are layered hexagonal (P₆/mmc), wherein pure layers of the A-group elements are interleaved with M_{N+1}X_{N} layers having a rock salt structure. As of the present, there have been identified roughly 50 M₂AX, or 211 compounds, three M₃AX₂ or 312 compounds (Ti₃SiC₂, Ti₃GeC₂, Ti₃AlC₂) and two M₄AX₃ or 413 compounds, namely, Ti₄AlN₃ and Ta₄AlC₃.

The MAX-phase class of materials may be described as polycrystalline nanolaminates. Like ceramics, MAX phase materials can be quite strong (1.5 GPa) in compression. They are readily machinable and to this end can be processed by such simple tools as a manual hacksaw or regular high-speed tool steels, with no lubrication or cooling required. Some, for example, Ti₃SiC₂, Ti₃AlC₂ and Ti₄AlN₃, are elastically quite stiff: at 320 GPa the stiffness of Ti₃SiC₂ is almost 3 times that of Ti metal, with the same density, namely, 4.5 g/cm³. Despite the high stiffness values, such materials remain readily machinable. This implies that some of the MAX phases have some of the highest specific stiffness values for readily machinable solids—with the exception of Be. MAX phase materials are also excellent conductors of electricity and heat; for example, the thermal and electrical conductivities of Ti₃SiC₂ are more than double those of Ti metal. Despite being layered they exhibit significant R-curve behavior, with fracture toughness values that exceed 15 MPa√m for coarse-grained samples. However, MAX-phase materials are not strong in tension. In other words, for applications requiring high tensile strengths, the MAX phases themselves could, in principle, be suitable for numerous uses that require reactive structures.

### SUMMARY

Disclosed are compositions comprising a MAX phase material having the formula Mₙ₊₁AXₙ, wherein M is an early transition metal, A is an A-group element, X one or both of C and N, and n=1-3, wherein the MAX phase material defines a plurality of pores; and, a metal component comprising a low melting point metal, wherein the metal occupies at least some of the pores. In certain embodiments the present compositions may comprise particles, such as grains or crystals, of the low melting point metal. The size of such particles may be from about 5 nm to about 50 nm, from about 10 nm to about 40 nm, or from about 15 nm to about 35 nm.

Also disclosed are methods comprising providing a porous green body comprising a particulate material having the formula Mₙ₊₁AXₙ, wherein M is an early transition metal, A is an A-group element, X one or both of C and N, and n=1-3; and, infiltrating at least some of the pores of the green body with a low melting point metal, thereby providing a composite material.

### BRIEF DESCRIPTION OF THE DRAWINGS

FIG. 1 provides: a) Schematic of a typical stress-strain curve for a KNE solid. The various parameters needed to describe the curve are labeled; and, b) Schematic of an IKB with length 2α and diameter 2β. D is the distance between the horizontal slip planes.

FIG. 2 provides secondary electron SEM images of a polished surface of Mg-50 vol. % Ti₂AlC composite fabricated by melt infiltration, showing the morphology of Ti₂AlC grains, a) parallel (MI-P) and b) normal (MI-N) to the basal planes.

FIG. 3 depicts optical micrographs of fully dense, polished and etched a) Ti₂AlC, and b) Ti₃SiC₂.

FIG. 4 illustrates the effect of indentation loads on the V_{H} values of the HP, MI-R, MI-P and MI-N samples, together with those of fully dense Ti₂AlC, pure Mg, Mg-312 and Mg—SiC for comparison. Inset in FIG. 4 shows a secondary electron SEM image of a Vickers indentation mark in the MI composite.

FIG. 5 provides a plot of ultimate compressive strength (UCS) values of certain tested materials.

FIG. 6 depicts: (a) Effect of volume fraction of MAX phase/metal composites on energy release for Al and Mg matrices; and, (b) Differential thermal analysis (DTA) of 7 mg of a 50-50 vol. % Nb₂AlC—Mg powder heated in air at 20° C./min. Two peaks are observed; the first one at ≈600° C.; the second around 750° C.

FIG. 7 depicts the compressive stress-strain curves of, a) MI-N, b) MI-P, c) MI-R, d) Mg—SiC and Mg-312, e) HP40 and f) HP50 composites; only one cycle per load is shown and the curves are shifted horizontally for clarity.

FIG. 8 depicts a) secondary electron SEM image of polished surface of Mg-50 vol. % Ti₂AlC composite fabricated by melt infiltration; 50 vol. % porous preforms of Ti₂AlC were made by cold pressing Ti₂AlC powder at 45 MPa. To carry out the infiltration process, pure Mg chunks were placed on top of the preforms that, in turn, were placed in Al₂O₃ crucibles covered with Al₂O₃ lids and placed in a graphite-heated hot press, HP, under a vacuum of 10⁻² torr, and held at 750° C. for 1 h, after which the furnace was turned off and the samples furnace cooled. Also shown (b) is the secondary electron SEM image of a fractured MI sample.

FIG. 9 a) and b) provide TEM images of the MI composite at low magnifications; at 2.87±0.05 Mg/m³, the density was 98% of theoretical. All the TEM foils were prepared by a conventional TEM sample preparation process: 0.5 mm-thick slices were first cut from bulk samples using a low-speed diamond saw. These pieces were further thinned with a Disc-Grinder to a thickness of about 20 μm. Final perforation was made by ion milling operating at 5 kV to achieve electron beam transparent areas. TEM characterization was performed using a field emission TEM operating at 200 kV; c and d) TEM images of same sample at higher magnifications showing the presence and morphology of nano-crystalline Mg matrix.

FIG. 10 illustrates full widths at half maximum (FWHM) of Mg and MgO vs. peak intensity. The three highest intensity peaks in Mg and two in MgO were compared with those of a Si standard, pure as-received Mg powder and Mg single crystal peaks. The typical MI composite XRD pattern contained peaks for Ti2AlC, Mg, TiC (5 vol. % impurity in the starting Ti2AlC powder) and MgO. Si was added as an internal standard.

FIG. 11 shows a) concentration of Mg and Ti within Ti₂AlC grains with average diameter of 12 μm verifying the formation of a (Ti₁₋ₓMgₓ)₂AlC solid solution, with an x as high as 0.2, b) Variation of a and c lattice parameters in as-received Ti₂AlC and that within the MI composite.

FIG. 12 provides DSC results: a) Three cycles of MI-Ti₂AlC composite, b)

Three cycles of HP-Ti2AlC composite, c) Comparison of melting troughs and, d) solidification peaks for five samples tested herein.

FIG. 13 depicts FDS spectra of a 40 mm high, 10 mm diameter, MI Ti₂AlC—Mg composite solid cylinder.

FIG. 14 depicts plots of, a) W_{d} vs. σ₂, b) ε_{NL} vs. σ₂, and c) W_{d} vs. ε_{NL} for Mg—Ti₂AlC composites tested herein and that of a fully dense Ti₂AlC for the sake of comparison; also shown are plots of, d) W_{d} vs. σ₂, e) ε_{NL} vs. σ₂, and f) W_{d} vs. ε_{NL} for Mg—Ti3SiC₂ and Mg—SiC composites.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention.

In the present disclosure the singular forms “a,” “an,” and “the” include the plural reference, and reference to a particular numerical value includes at least that particular value, unless the context clearly indicates otherwise. Thus, for example, a reference to “a material” is a reference to one or more of such materials and equivalents thereof known to those skilled in the art, and so forth. When values are expressed as approximations, by use of the antecedent “about,” it will be understood that the particular value forms another embodiment. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

The disclosures of each patent, patent application, and publication cited or described in this document are incorporated herein by reference, in their entirety.

The present invention pertains to the discovery that the infiltration of MAX-phase materials with one or more low melting point metals results in composite substances that are characterized by, inter alia, high tensile strength, high machinability, elevated energy release profiles, and other mechanical and chemical properties that render them superior to ordinary MAX-phase materials in numerous respects. As used herein, “low melting point metals” generally refers to metals that have a melting point of less than about 750° C., but may also include some metals that have a melting point of less than about 1800° C., such as titanium. However, with respect to the compositions of the present invention, where the MAX-phase material is Ta₂AlC or Cr₂AlC, the “low melting point metal” may not be Ag, and where the MAX-phase material is Ti₃SiC₂ or Ti₂SnC, the “low melting point metal” may not be Cu; such restrictions may not apply with respect to the methods of the present invention.

It has been discovered that low melting point metals spontaneously infiltrate into the pores of a material comprising MAX phase materials to form fully dense, uniform microstructures. For example, when a solid, low melting point metal is contacted with a MAX phase material and subjected to heating, it has been found that the low melting point metal infiltrates the porous MAX phase material, thereby resulting in novel MAX phase-metal composite materials. For example, in vacuum atmosphere, at 750° C., pure Mg spontaneously infiltrates porous MAX preforms to form fully dense, uniform microstructures. In other words, little (e.g., less than about 30 MPa, less than about 20 MPa, less than about 10 MPa, less than about 5 MPa, less than about 2 MPa, or less than about 1 MPa) or no external pressure is needed, and thus the process may be rapid and spontaneous. Alternatively, the MAX phase material may be partially or fully immersed in a liquid bath of a low melting point metal in order to infiltrate the pores of the MAX phase material with the metal. In other embodiments the low melting point metal may be infiltrated into the pores of the MAX phase material by hot pressing. Both melt infiltration and hot pressing are techniques with which those of ordinary skill in the art are familiar; the present application includes descriptions of exemplary melt infiltration and hot pressing procedures, respectively, that may be varied as needed in view of particular processing requirements. The incorporation of the metal into the MAX phase matrix forms the instant high tensile strength, high machinability, elevated energy release materials.

The composites of the present invention may additionally comprise fibers that can, inter alia, further enhance the ultimate tensile strength of the material. Additionally or alternatively, the orientation of the MAX-phase material microstructures during the manufacture of the present composites can result in enhanced tensile strengths. During formation of the instant composites, the use of solid solutions whereby one or more of the M-site, A-site, X-site, or metal phase elements are substituted by compatible alternative element(s) can result in the enhancement of the ultimate tensile strength, density, and/or reactivity of the ultimate composites. The inclusion of one or more oxidizing agents, such as polytetrachloroethylene (PTFE) or potassium perchlorate, may be used to improve the reactivity of the present composites.

Provided are compositions comprising a MAX phase material having the formula Mₙ₊₁AXₙ, wherein M is an early transition metal, A is an A-group element, X is one or both of C and N, and n=1-3, wherein said MAX phase material defines a plurality of pores; and, a metal component comprising a low melting point metal, wherein said metal occupies at least some of said pores. Where X comprises carbon, at least some of X may further comprise nitrogen; likewise, where X comprises nitrogen, at least some of X may further comprise carbon. As used herein, “early transition metal” means one or more of tantalum, hafnium, titanium, vanadium, chromium, niobium, molybdenum, scandium, and zirconium. Titanium, tantalum and hafnium represent preferred embodiments. In some embodiments, at least some of M may comprise a second one of tantalum, hafnium, titanium, vanadium, chromium, niobium, molybdenum, or zirconium. As used herein, an “A-group element” refers to aluminum, tin, silicon, phosphorous, sulfur, gallium, germanium, arsenic, cadmium, indium, thallium, or lead. Aluminum, tin, and lead represent preferred embodiments. In some embodiments, at least some of A may comprise at a second one of aluminum, tin, silicon, phosphorous, sulfur, gallium, germanium, arsenic, cadmium, indium, thallium, or lead. The substitution of at least some of M, A, and/or X with at least some of another M, A, and/or X element, respectively, may be accomplished through the use of MAX phase solid solution chemistry, which is described in more detail infra, in Example 3.

The metal may be present in the composition in an amount of about 10 to about 70% by volume. For example, the metal may be present in an amount of about 10% by volume, 20% by volume, 25% by volume, 30% by volume, 35% by volume, 40% by volume, 45% by volume, 50% by volume, 55% by volume, 60% by volume, or about 70% by volume. As used herein, unless otherwise specified, a percentage by volume measurement refers to the percentage by volume of the metal within the composition. The metal component may comprise one or more of aluminum, bismuth, indium, lead, magnesium, sodium, tin, titanium, copper, silver, and zinc. In preferred embodiments, the metal component is magnesium or aluminum. In other embodiments, the metal component may comprise an “alloy”, which may include two or more “low melting point metals”, a “low melting point metal” combined with one or more alloying agents that do not otherwise qualify as a “low melting point metal”, or both. For example, the metal component may be an alloy of magnesium, such as AZ91 (9% Al, 1% Zn, and 0.2% Mn, the balance being Mg), AZ80 (8% Al, 0.5% Zn, and 0.2% Mn, the balance being Mg), AZ31B (2.5%-3.5% Al, at least 0.20% Mn, 0.60%-1.4% Zn, ≦0.04% Ca, ≦0.10% Si, ≦0.05% Cu, ≦0.005% Ni, ≦0.005% Fe, ≦0.30% other; the balance being Mg). In other embodiments, the metal component may be an alloy of magnesium and one or more other “low melting point metals”, an alloy of magnesium and one or more metals or other components that are not “low melting point metals”, or a combination thereof. For example, the metal component may be an alloy of magnesium and aluminum. The alloy may include about 20-80% magnesium and about 20-80% aluminum.

The composition may further comprise fibers in an amount of about 5 to about 50% by volume. Such fibers may provide structural reinforcement for the composition. Suitable fibers will be readily appreciated by those skilled in the art and may include one or more of ceramic fibers, aramid fibers, carbon fibers, glass fibers, polyamide fibers, polyethylene fibers, or polyester fibers. The fibers may include short fibers in the form of pulp fibers or staple fibers. The fibers may have an average fiber length of between about 10 μm and about 2500 μm. In some embodiments, the longest fibers do not exceed 1000 μm to 2000 μm. Particularly preferred in this context are glass, carbon, or ceramic fibers.

The fibers may be at least partially present in the form of a woven mass. The composition may include at least one layer of the combination of the MAX phase material and the metal component, and at least one layer of fibers. For example, the composition may comprise multiple layers of MAX phase/metal combination that alternate with multiple layers of fibers.

The present compositions may further comprise one or more oxidizing agents. Oxidizing agents may be included in order to, inter alia, increase the likelihood of ignition of the present compositions. Those skilled in the art may readily identify exemplary oxidizing agents. For example, the oxidizing agent may comprise one or more of polytetrafluoroethylene and potassium perchlorate. The oxidizing agent may be present in the composition in an amount of about 20 to about 60% by volume. The oxidizing agent may be coated onto the combination of the MAX phase and metal component, or may be present in the composition in the form of one or more particles, grains, rods, spheres, chips, or layers.

Also disclosed are reactive materials comprising a composition comprising a MAX phase material having the formula Mₙ₊₁AXₙ, wherein M is an early transition metal, A is an A-group element, X one or both of C and N, and n=1-3, wherein said MAX phase material defines a plurality of pores; a metal component comprising a low melting point metal, wherein said metal occupies at least some of said pores; and, an oxidizing agent. Oxidizing agents may be present in the reactive material in accordance with the preceding disclosure. The reactive material may be an explosive or a projectile.

Methods for producing novel MAX phase-based composite materials are also disclosed. Provided are methods comprising providing a porous green body comprising a particulate material having the formula Mₙ₊₁AXₙ, wherein M is an early transition metal, A is an A-group element, X one or both of C and N, and n=1-3; infiltrating at least some of the pores of the green body with a low melting point metal, thereby providing a composite material. The green body may have a porosity up to about 70%. Following the infiltration of the green body with the metal, the resulting composite material may have a porosity that is about 30% or lower, about 20% or lower, about 10% or lower, or about 5% or lower. Stated differently, the composite material may have a density that is about 70% or higher, about 80% or higher, about 90% or higher, about 95% or higher, or about 100%.

The provision of the green body may include forming a green body by compacting a powder comprising the particulate material. The compaction of powders to form green bodies is a well-known process and typically includes pouring or otherwise placing a powder into a mold, and subjecting the mold to pressure by compaction. Compaction may be uniaxial, multi-axial, or isostatic. To impart the green body with enough mechanical strength to withstand the infiltration step, a sintering step where the green body is heated to higher temperatures may precede the infiltration step.

Where the provision of a green body includes forming the green body, prior to forming the green body, the present methods may further comprise orienting the particles of the particulate compound. The particles of the particulate compound may be flake-like in structure, and orienting particles may be as simple as “tapping” a vessel in which the particles are housed. Other methods may include shaking, vibrating, or shifting the vessel in which the particles are housed. The orientation of the particles in accordance with the present invention may also be referred to as the orientation of the microstructures of the present particulate materials, and is described in greater detail infra.

The present methods may further comprise compacting the composite material under elevated temperatures to provide a compacted composite. The compaction of the composite material may be conducted in accordance with methods that will be readily appreciated by those skilled in the art. For example, compacting may be uniaxial, multi-axial, or isostatic. In preferred embodiments, a hot isostatic press technique is used to compact the composite material.

The low melting point metal may be hardened, and the hardening may comprise one or more of solid solution hardening, precipitation hardening, and work hardening, each of which techniques are well known among those skilled in the art. The hardening may take place following the infiltration of the low melting point metal into the pores of the green body.

The green body in accordance with the present methods may comprise fibers. Such fibers may provide structural reinforcement for the green body and/or the ultimate composite material. Suitable fibers will be readily appreciated by those skilled in the art and may include one or more of aramid fibers, carbon fibers, glass fibers, polyamide fibers, ceramic fibers, or polyester fibers. The fibers may include short fibers in the form of pulp fibers or staple fibers. The fibers may have an average fiber length of between about 10 μm and about 2500 μm. In some embodiments, the longest fibers do not exceed 1000 μm to 2000 μm. Particularly preferred in this context are glass fibers, ceramic fibers of the aramid fiber type, or also carbon fibers. The fibers may be at least partially present in the form of a woven mass. The green body may include one or more layers of the particulate material, and one or more layer of fibers. For example, the composition may comprise multiple layers of particulate material that alternate with multiple layers of fibers.

In the green bodies according to the present methods, where X comprises carbon, at least some of X may further comprise nitrogen; likewise, where X comprises nitrogen, at least some of X may further comprise carbon. M may be tantalum, hafnium, titanium, vanadium, chromium, niobium, molybdenum, or zirconium, tantalum or hafnium being preferred. In some embodiments, at least some of M may comprise at a second one of tantalum, hafnium, titanium, vanadium, chromium, niobium, molybdenum, or zirconium. A may be aluminum, tin, silicon, phosphorous, sulfur, gallium, germanium, arsenic, cadmium, indium, thallium, or lead, aluminum or lead being preferred. In some embodiments, at least some of A may comprise at least a second one of aluminum, tin, silicon, phosphorous, sulfur, gallium, germanium, arsenic, cadmium, indium, thallium, or lead. The substitution of at least some of M, A, and/or X with at least some of another M, A, and/or X element, respectively, may be accomplished through the use of MAX phase solid solution chemistry, which is described in more detail infra.

The metal may be infiltrated into the green body in an amount of about 10 to about 60% by volume. For example, the metal may be infiltrated in an amount of about 10% by volume, 20% by volume, 25% by volume, 30% by volume, 35% by volume, 40% by volume, 45% by volume, 50% by volume, 55% by volume, or 60% by volume. The metal component may comprise one or more of aluminum, bismuth, indium, lead, magnesium, sodium, tin, titanium, and zinc. In preferred embodiments, the metal component is magnesium and/or aluminum. As described previously, the metal component may be an alloy. The metal component may be infiltrated into the green body by melt infiltration or by hot pressing.

### EXAMPLES

### Example 1

### Mₙ₊₁AXₙ Phases

MAX phase materials are layered hexagonal (P6/mmc), wherein pure layers of the A-group elements are interleaved with MN+1XN layers having the rock salt structure.

Known MAX phase materials are summarized below in Table 1:

TABLE 1

| | | | | |
|---|---|---|---|---|
| | Al | Si | P | S |
| | Ti₂AlC, 4.11 (3.04, 13.60) | Ti₃SiC₂4.52 (3.0665, 17.671) | V₂PC 5.38 (3.077, 10.91) | Ti₂SC, 4.62 (3.216, 11.22) |
| | V₂AlC, 4.82 (2.914, 13.19) | | Nb₂PC 7.09 (3.28, 11.5) | Zr₂SC, 6.20 (3.40, 12.13) |
| | Cr₂AlC, 5.24 (2.86, 12.8) | | | Nb₂SC_{0.4}, (3.27, 11.4) |
| | Nb₂AlC, 6.50(3.10, 13.8) | | | Hf₂SC, (3.36, 11.99) |
| | Ta₂AlC, 11.82 (3.07, 13.8) | | | |
| | Ti₂AlN, 4.31 (2.989, 13.614) | | | |
| | Ti₃AlC₂, 4.5 (3.075, 18.578) | | | |
| | Ti₄AlN₃, 4.76 (2.988, 23.372) | | | |
| | Ta₄AlC₃, 13.77 (3.08, 23.13) | | | |
| Zn | Ga | Ge | As | Se |
| | Ti₂GaC, 5.53 (3.07, 13.52) | Ti₂GeC, 5.68 (3.07, 12.93) | V₂AsC 6.63 (3.11, 11.3) | |
| | V₂GaC, 6.39 (2.93, 12.84) | V₂GeC, 6.49 (3.00, 12.25) | Nb₂AsC 8.025 (3.31, 11.9) | |
| | Cr₂GaC, 6.81 (2.88, 12.61) | Cr₂GeC, 6.88 (2.95, 12.08) | | |
| | Nb₂GaC, 7.73 (3.13, 13.56) | Ti₃GeC₂, 5.55 (3.07, 17.76) | | |
| | Mo₂GaC, 8.79 (3.01, 13.18 | | | |
| | Ta₂GaC, 13.05 (3.10, 13.57) | | | |
| | Ti₂GaN, 5.75 (3.00, 13.3) | | | |
| | Cr₂GaN, 6.82 (2.875, 12.77) | | | |
| | V₂GaN, 5.94 (3.00, 13.3) | | | |
| Cd | In | Sn | Sb | Te |
| Ti₂CdC 9.71 (3.1, 14.41) | Sc₂InC | Ti₂SnC, 6.36 (3.163, 13.679) | | |
| | Ti₂InC, 6.2 (3.13, 14.06) | Zr₂SnC, 7.16 (3.3576, 14.57) | | |
| | Zr₂InC, 7.1 (3.34, 14.91) | Nb₂SnC, 8.4 (3.241, 13.802) | | |
| | Nb₂InC, 8.3 (3.17, 14.37) | Hf₂SnC, 11.8 (3.320, 14.388) | | |
| | Hf₂InC, 11.57 (3.30, 14.73) | Hf₂SnN, 7.72 (3.31, 14.3) | | |
| | Ti₂InN, 6.54 (3.07, 13.97) | | | |
| | Zr₂InN, 7.53 (3.27, 14.83) | | | |
| | Tl | Pb | Bi | |
| | Ti₂TlC, 8.63(3.15, 13.98) | Ti₂PbC, 8.55 (3.20, 13.81) | | |
| | Zr₂TlC, 9.17 (3.36, 14.78) | Zr₂PbC, 9.2 3.38, 14.66 | | |
| | Hf₂TlC 13.65 (3.32, 14.62) | Hf₂PbC, 12.13 (3.55, 14.46) | | |
| | Zr₂TlN, 9.60 (3.3, 14.71) | | | |

The theoretical density (g/cm³) is in bold letters. The densities (ρ) of the MAX phases range from a low of 4.1 g/cm³ for Ti₂AlC and a high of 13.9 g/cm³. The a and ε-lattice parameters (A) are in parenthesis. Most of this list appeared in a 1970 review paper, H. Nowotny, “Struktuchemie Einiger Verbindungen der Ubergangsmetalle mit den elem enten C, Si, Ge, Sn”, Progress in Solid State Chem., H. Reiss, Ed., p. 27, (1970), incorporated herein by reference. The list does not include solid solutions, which will be described more fully herein with respect to the present invention.

There are several properties of these solids that make them well suited to various applications:

a) They are polycrystalline solids that may be characterized as thermodynamically stable nanolaminates. The extent by which grains in these solids will delaminate and deform at room temperature is unique. Basal plane dislocations, and only basal plane dislocations, are mobile and multiply at temperatures as low as 77 K. The dislocations glide exclusively on the basal planes and are overwhelmingly arranged either in arrays or kink boundaries. Single grains can deform by a combination of slip, kink band formation and delaminations, all of which are dislocation based.

b) A characteristic property of the MAX phases is the ease by which they can be machined with nothing more sophisticated than a manual hacksaw or regular high-speed tool steels, with no lubrication or cooling required. Some of them (e.g., Ti₃SiC₂, Ti₃AlC₂ and Ti₄AlN₃) are elastically quite stiff (at 320 GPa the stiffness of Ti₃SiC₂ is almost 3 times that of Ti metal, with the same density, namely 4.5 g/cm³). Despite the high stiffness values they are readily machinable. This implies that some of the MAX phases have the highest specific stiffness values for readily machinable solids—with the exception of Be.

c) Crystal plasticity is by definition irreversible; once dislocations are generated they entangle and render the process irreversible. It has previously been shown that this definition does not apply to Ti₃SiC₂ (M. W. Barsoum, T. Zhen, S. Kalidindi, M. Radovic and A. Murugaiah, “Fully Reversible, Dislocation-Based Compressive Deformation of Ti₃SiC₂ up to 1 GPa”, Nature Materials, 2, 107-111 (2003), incorporated herein by reference). Macroscopic polycrystalline Ti₃SiC₂ cylinders can be compressed, at room temperature, to stresses of up to 1 GPa, and fully recover upon the removal of the load. The stress-strain curves are non-linear, outline fully reversible, reproducible closed loops whose size and shape depend on grain size, but not strain rate. This phenomenon—one description of which is fully reversible plasticity—is attributed to the formation and annihilation of incipient kink bands, defined to be thin plates of shear material bounded by opposite walls of dislocations. The energy absorbed per cycle, 0.7 MJ/m³, at 1 GPa is quite high. For example, the loss factors for Ti₃SiC₂ are higher than most woods and comparable to polypropylene and nylon. And the damping properties of Ti₃SiC₂ are orders of magnitude higher than those of other structural ceramics.

d) They are excellent conductors of electricity and heat; for example, the thermal and electrical conductivities of Ti₃SiC₂ are more than double those of Ti metal.

e) Despite being layered they exhibit significant R-curve behavior, with fracture toughness values that exceed 15 MPa√m for coarse-grained samples. Part of the reason for this relatively high fracture toughness values are the extremely tenacious nanolaminates holding the crack together as well as the extent by which large grains of Ti₃SiC₂ can bend and curl on themselves even at room temperature.

f) The mechanical response of Ti₃SiC₂ is a strong function of temperature, type of loading, and strain rate. At relatively slow strain rates the sample plastically deforms—up to 25%; at moderate higher strain rates the failure is brittle. MAX phases all go through a brittle-to-plastic transition at elevated temperatures. The transition is not a brittle-to-ductile transition because it is accompanied by a decrease in fracture toughness rather than an increase. In other words, the transition is not due to the activation of non-basal slip systems. The latter are virtually impossible to activate because of the exceedingly high c/a ratio (>3).

### Example 2

### MAX Phase/Metal Composite Materials

Although not intending to be limited to any particular usage, Ti₂AlC/Mg was explored with an eye towards applications in the automotive and other consumer products, because of that composition's low density. In Ar or vacuum atmospheres, at 750° C., pure Mg spontaneously infiltrates porous MAX performs to form fully dense, uniform microstructures. The composites are also as machinable as some Al alloys. These characteristics enable the delivery of large complex parts rapidly and economically.

After furnace cooling the Mg grain size of the Mg matrix was found to be in the nanometer scale (FIGS. 9c and 9d). Consequently, 50 vol. % Mg/Ti₂AlC samples had compressive strengths (700 MPa) that were not much lower than those of fully dense, pure Ti₂AlC samples with compressive strengths of 870 MPa. This is a significant result considering that the Mg used to infiltrate was pure, i.e., unalloyed. This result would not have been possible had the Mg grain size not been in the nanoscale. For comparison, a 50 vol. % Mg/SiC composite sample in which the Mg grains were not in the nanoscale had a compressive strength of ≈500 MPa (see FIG. 7d).

Another property germane to this disclosure are the tensile strengths. Five 50 vol. % Ti₂AlC/Mg samples were tested; their average tensile strength was 350±40 MPa. Such strengths are seldom achieved even in the strongest commercial Mg-alloys. If the nano-size of the Mg grains can be maintained for Mg-alloys it is not unreasonable to assume that ultimate tensile strengths of 100 ksi would be achievable.

When the samples fail, especially at high strain rates, the failure is brittle. It is thus not unreasonable to assume that when hitting a target, a 50-50 vol. % MAX/Mg or MAX/Al composite would shatter. This is especially true if the adiabatic temperature upon impact exceeds 700° C., which is higher than the melting points of either Mg or Al.

The following are calculations of the energy released when a 50 vol. % Mg/Ta₄AlC₃ reacts with oxygen. Here it is assumed that the relevant reaction is:

Ta₄AlC₃+4.25O₂=2 Ta₂O₅+1/2 Al₂O₃+3CO₂ (1)

Mg+1/2O₂=MgO (2)

ΔH_{form} of Ta₄AlC₃ is not known. However, it has been shown that at least for Ti₃SiC₂, a very good approximation is to assume the A atoms act as X atoms (M. W. Barsoum, “The MN+1AXN Phases: A New Class of Solids: Thermodynamically Stable Nanolaminates”, Prog. Sol. State Chem., 28, 201-281 (2000), incorporated herein by reference). In other words, assuming ΔH_{form} of Ta₄AlC₃≈4 ΔH_{form} TaC is a good approximation.

Starting with a basis of 1 cm³ of a 50-50 vol. % Mg/Ta₄AlC₃ composite sample, it follows that we have 0.5 cm³ of Ta₄AlC₃ and 0.5 cm³ of Mg, which translate to:

0.5*13.77=6.885 g of Ta₂AlC

and

0.5*1.74=0.87 g of Mg

assuming densities of 13.77 and 1.74 g/cm³, for Ta₄AlC₃ and Mg, respectively. Dividing both values by 7.75 results in 0.89 gm of Ta₄AlC₃ and 0.11 g of Mg. The total weight of the two components is now ≈1 g. The molecular wt of Ta₄AlC₃ is 787 g/mol; that of Mg is 24.3 g/mol.

Thus in 1 gm of 50-50 Ta₂AlC/Mg composite:

0.89/787=0.0011 moles of Ta₄AlC₃

and

0.11/24.3=0.0046 moles of Mg

Using the ΔH_{form} values listed below in Table 2, the energy release for reaction 1 at 1300 K is:

0.0011[−2×460−481/2−3×111.4+138]*1000=1492 cal/gm

For reaction 2 it is:

0.0046*145*1000=−667 cal/mol

Thus the sum of the two reactions is −2159 cal/gm, which is >1500 cal/g.

TABLE 2
Summary of ΔH_{form} values used in the energy
release calculations (values are in kcal/mol)

| Compound | ΔH_{form} at 1300 K | ΔH_{form} at 300 K | Comments |
|---|---|---|---|
| MgO | −145.41 | −143.8 | |
| Al₂O₃ | −481 | −400.6 | |
| Ta₂O₅ | −460 | −468.2 | |
| HfO₂ | | −266.2 | |
| SnO₂ | | −138.8 | |
| Ta₄AlC₃ | −138 | | 4 × ΔH_{form} of TaC |
| Ta₂AlC | −69 | | 2 × ΔH_{form} of TaC |
| Hf₂SnC | | −119.7 | 2 × ΔH_{form} of HfC |

FIG. 6(a) summarizes the effect of the volume fraction of MAX phase/metal composites on energy release for Al and Mg matrices. Note that in all cases, the energy released is >1500 cal/g; in the Al case significantly so.

It is assumed that all elements oxidize to their highest oxidation state and the heat needed to heat the reactants to 1300 K is ignored. The former is a good assumption because the oxidation of the MAX phases are almost always in their highest oxidation state. The latter is also an good assumption since the energy needed to heat the ingredients is quite small, of the order of 50 cal/g.

Table 3, below, summarizes the calculated energy releases—and densities—of the MAX phase/metal composites proposed herein. For the most part, the energy release is >1500 cal/mol; in some cases almost 3 times that value.

TABLE 3

| | | | | | | | Energy |
|---|---|---|---|---|---|---|---|
| | | | PTFE | Sample | | Density | release |
| MAX Phase | Metal | Vol. % metal | % | Repeats | Velocities | (g/cm³) | (cal/g) |
| Ta₂AlC | | 0 | 0 | 3 | 3 | 11.8 | 1811 |
| | Al | 30 | 0 | 3 | 1 | 9.1 | 2316 |
| | | 40 | 0 | 3 | 3 | 8.2 | 2560 |
| | | 50 | 0 | 3 | 1 | 7.3 | 2865 |
| | | 60 | 0 | 3 | 1 | 6.3 | 3257 |
| | Mg | 30 | 0 | 3 | 3 | 8.8 | 2059 |
| | | 40 | 0 | 3 | 1 | 7.8 | 2184 |
| | | 50 | 0 | 3 | 1 | 6.8 | 2347 |
| | | 60 | 50 | 3 | 1 | 5.8 | 2567 |
| | Al | 25 | 25 | 3 | 1 | 6.9 | 2353 |
| Ta₄AlC₃ | | 0 | 0 | 3 | 3 | 13.8 | 1732 |
| | Al | 40 | 0 | 3 | 1 | 9.3 | 2396 |
| | | 50 | 0 | 3 | 3 | 8.2 | 2674 |
| | | 60 | 0 | 3 | 1 | 7.1 | 3038 |
| | Mg | 40 | 0 | 3 | 3 | 9.0 | 2062 |
| | | 50 | 0 | 3 | 1 | 7.8 | 2209 |
| | | 0 | 50 | 3 | 1 | 7.5 | 1713 |
| | Al | 25 | 25 | 3 | 1 | 7.9 | 2216 |
| Hf₂SnC | | 0 | 0 | 3 | 3 | 11.8 | 1359 |
| | Mg | 40 | 0 | 3 | 1 | 7.8 | 1773 |
| | | 50 | 0 | 3 | 3 | 6.8 | 1954 |
| | | 60 | 0 | 3 | 1 | 5.8 | 2197 |

Based on the following two observations, it is strongly believed that MAX phase/metal composites would ignite. First, Hf₂SnC samples are one of the most ignitable MAX phase powders. Second, the DTA/TGA of a Nb₂AlC/Mg powder drilled out from a fully dense 50 vol. % pressureless infiltrated compact, heated in air at a moderate 20° C./min ignited at 600° C. (FIG. 6(b)).

To the extent that ignition may not occur because of oxygen starvation, the present compositions and methods can comprise including a source of oxygen, i.e., an oxidizing agent, in or in association with the present MAX phase/metal composites. Those skilled in the art may readily identify exemplary oxidizing agents. For example, the oxidizing agent may comprise one or more of polytetrafluoroethylene and potassium perchlorate. The oxidizing agent may be present in the composition in an amount of about 20 to about 60% by volume. The oxidizing agent may be coated onto the combination of the MAX phase and metal component, or may be present in the composition in the form of one or more particles, grains, rods, spheres, chips, or layers.

### Example 3

### Enhancement of Properties of MAX Phase/Metal Composites

Other additional approaches may be used with respect to the present compositions and methods in order to enhance the properties of the resulting composite material, such as: i) alloying, ii) the introduction of graphite and/or ceramic fibers, iii) Oriented microstructures, iv) metal volume fraction, and, v) solid solutions in the MAX phases.

i) Alloying: The ultimate tensile strengths can be enhanced by solid solution hardening, precipitation hardening and/or possibly work hardening if the MAX phase/metal composites are not too brittle. The latter can be enhanced by increasing the metal volume fractions (see below).

A potent source of alloying elements is the MAX phase itself. Mg and Al are fairly reactive metals that will, and do, react with the MAX phases. For example when Al is reacted with Ti₃SiC₂ the following reaction is observed:

Ti₃SiC₂+Al═TiCₓ+Si(Al)

where Si is dissolved in the Al matrix. Not surprisingly, when Al—Si alloys are used instead the reaction is suppressed. The critical concentration at which the reaction is suppressed is important and can be used to actually calculate the free energies of the MAX phase, provided that the activity of the A-group element in the metal matrix is known. For reaction, that would be the Al—Si liquid solution activities that are well known.

Similarly, when Ag/Ta₂AlC composites are manufactured the following reaction is observed:

Ta₂AlC+Ag=Ta₂Al_{1-δ}C+Ag₂Al

The formation of intermetallics can also be exploited to enhance the tensile properties of the composites.

In the Mg/Ti₂AlC composites described herein the Mg diffuses into the MAX phase and Ti diffuses out into the Mg matrix. No Ti-rich regions were found in TEM and it is thus presumed to be in solid solution despite the fact that the solubility of Ti in Mg is almost zero at room temperature. Not wishing to be bound by any one theory, such a result could be related to the nanometer scale of the Mg grains (see FIGS. 9c and 9d)

Lastly it is noted that good mechanical properties in metal matrix composites depend on having strong interfaces between matrix and reinforcement. By understanding the reaction kinetics and thermodynamics of the metal matrix/MAX interfaces these interfaces can be tailored to maximize the tensile and other mechanical properties such as fracture toughness.

ii) Fiber reinforcement: it is well established in the composites literature that reinforcing metal matrix composites with fibers can enhance their ultimate tensile strengths. The relatively low (<750° C.) temperature composite processing routes described herein should not degrade the tensile strengths of the fibers, which is probably one of the major problems faced when higher temperature matrices are used, as in the case of ceramic/ceramic composites. The low processing route would also facilitate and reduce the cost of what is usually a laborious and expensive process, especially when relatively large and complex ceramic/ceramic composites are fabricated.

iii) Oriented microstructures. The MAX phases are layered hexagonal and their response depends on their texture. FIG. 7 shows the effect of orienting the basal planes relative to the loading direction in fully dense Ti₂AlC. Since a major deformation mode of the MAX phases is kinking, it is not surprising that when the basal planes are loaded edge on (FIG. 7a) they kink much more easily. If the load is normal to the basal planes (FIG. 7b) the deformation is much reduced and the area of the loops are also. The energy dissipated per cycle per unit volume is due to the formation and annihilation of incipient kink bands.

Based on these results, it is reasonable to assume that the ultimate tensile strength of a MAX phase/metal composite could be significantly enhanced if pulled along the basal planes (i.e., FIG. 7a). It follows that orienting the grains along the tensile axis should result in solids that are simultaneously stronger in tension, but weaker in compression along the axis of impact. Orienting the grains involves, for example, gentle tapping of the powder compacts; the flake-like nature of the MAX powders results in their orientation.

iv) Metal matrix volume fraction. Varying the metal volume fraction of the MAX phase/metal composites will have a profound impact on both the mechanical and energy release properties. Therefore, this is believed to be an important microstructural variable.

v) MAX phase solid solutions. Another property related to the composites of the present invention is the ability to fabricate almost a limitless number of MAX-phase solid solutions. For example, it is possible to create solid solutions on the M-sites, the A-sites and the X-sites. Interestingly, only the latter result in significant enhancements of the mechanical properties (M. W. Barsoum, M. Ali and T. El-Raghy, “Processing and Characterization of Ti₂AlC, Ti₂AlN and Ti₂AlC_{0.5}N_{0.5}”, Met. Mater. Trans., 31A, 1857 (2000), incorporated herein by reference). For example, substitution of half the C atoms with N to form Ti₂Al(C_{0.5}N_{0.5}) solid solutions results in an increase in the compressive strengths, from 600 MPa to 900 MPa.

This degree of freedom permits the ability to tailor the densities of the MAX phases—and thus the reactive structure—almost at will. For example, replacing ½ the Al atoms in Ta₄AlC₃ with Sn increases the density 13.77 to 14.55 g/cm³.

Lastly, such substitutions can be manipulated to enhance the reactivity of the reactive structures. For example, if one found that Hf₂SnC is much more reactive than the Ta-containing samples, but are too explosive to handle, then one could incorporate the Hf in the Ta-containing MAX phase by starting with (Ta,Hf)₂AlC or (Ta,Hf)₂(Al,Sn)C and even possibly, (Ta,Hf)₂(Al,Sn)(C,N) MAX phases. In other words, one may independently tailor for density, reactivity and mechanical properties enhancements.

### Example 4

### Energy Release and Porosity Studies

To determine the energy release of selected reactive materials, one may perform energy release experiments to examine the exothermic reaction efficiency of tested reactive materials.

A 40 mm smooth bore powder gun is used to launch selected materials at velocities of 3000, 6000, and 8000 ft/s. The gun system uses four-piece self discarding polycarbonate sabots to encapsulate and protect the reactive materials.

For each of the three different velocity shots, the projectile perforates a thin (0.0625″) steel membrane and enters into a cylindrically symmetric enclosed chamber. The enclosed chamber incorporates a suite of piezoelectric pressure gages to evaluate the overpressure related to energy release. The energy release is correlated to the over pressure measured from the pressure gages within the chamber. Based on the pressure and using modeling by Myruski et al. (JANAF Thermochemical Tables, 2008), incorporated herein by reference, it is possible to determine the energy release for each fragment tested at the three different impact velocities.

Further testing to determine energy release processes may include high speed visible spectroscopy, high speed UV spectroscopy, calorimetery, gas collection during impact, solid residue collection during impact, X-ray imaging, and total light measurements.

### Example 5

### Additional Materials—Ti₂AlC/Mg and Other Exemplary Composites

The following disclosure provides additional information pertaining to the present invention (see also S. Amini et al., Composites Science and Technology, 69 (2009) 414-420, incorporated herein by reference).

The Mₙ₊₁AXₙ (MAX) phases are layered hexagonal solids with two formula units per unit cell, in which near close-packed layers of M are interleaved with layers of pure A-group elements, with the X-atoms filling the octahedral sites between M layers. t is fairly well established that these phases have an unusual and sometimes unique combination of properties. For example, they are excellent electrical and thermal conductors, thermal shock resistant and damage tolerant. Despite being elastically quite stiff, they are all readily machinable with nothing more sophisticated than a manual hacksaw. Moreover, some of them are fatigue, creep and oxidation resistant. More recently, the MAX phases were classified as kinking nonlinear elastic (KNE) solids because they deform primarily by kinking, and the formation of kink bands. Kinking—a mechanism first reported by Orowan in single crystals of Cd loaded parallel to the basal planes—has also been identified as the physical origin of the hysteretic, nonlinear elastic behavior exhibited by these solids. Kink band formation is a key mechanism without which the deformation of the KNE solids, in general, and the MAX phases in particular, cannot be understood. Experimentally, the signature of KNE solids is the formation of fully reversible, hysteretic stress-strain loops during cyclic loadings. This full reversibility has been attributed to the formation of incipient kink bands (IKBs) that are comprised of multiple, parallel dislocation loops, whose shape ensures that when the load is removed they shrink significantly or are annihilated altogether.

More recently, magnesium, Mg, and its alloys have been extensively used in various industries due to their lightweight. The density of magnesium is approximately two thirds of that of aluminum, one quarter of zinc, and one fifth of steel. As a result, magnesium and its alloys offer a very high specific strength among conventional engineering alloys. In addition, magnesium alloys possess excellent castability and superior machinability. Mg is also well known for its high damping capabilities. It has been shown that the high damping can be traced to the formation of IKBs (see A. G. Zhou, S. Basu, and M. W. Barsoum, Kinking nonlinear elasticity, damping and microyielding of hexagonal close-packed metals. Acta Materialia 56 (2008) 60-7, incorporated herein by reference). In other words, it has been shown that Mg—and other hexagonal metals, including Ti, Co and Zn—are KNE solids.

Compared to other structural metals, magnesium alloys have a relatively low strength, especially at elevated temperatures that limits their applications to temperatures of up to 120° C. But the need for high-performance and lightweight materials for some demanding applications has led to the development of magnesium matrix composites with cost-effective fabrication technologies. Despite all advantages, the major drawbacks of Mg matrix composites usually lie in the relatively high cost of fabrication and of the reinforcement materials. Therefore the cost-effective processing is a preferred element for expanding their applications.

In general, there has not been much work on MAX-metal composites. Recently, the fabrication of Ta₂AlC and Cr₂AlC Ag-based composites that can be used—over a wide temperature range—as solid lubricant materials against Ni-based superalloys and alumina has been reported (S. Gupta, D. Filimonov, T. Palanisamy, T. El-Raghy, and M. W. Barsoum, Ta₂AlC and Cr₂AlC Ag-based composites—New solid lubricant materials for use over a wide temperature range against Ni-based superalloys and alumina. Wear 262 (2007) 1479-1489, incorporated herein by reference). There are also a few papers on Ti₃SiC₂—Cu composites (see Z. Zhang, and S. Xu, Copper-Ti3SiC2 composite powder prepared by electroless plating under ultrasonic environment, Rare Metals 26 (2007) 359-364; T. L. Ngai, X Zhiyu, W. Yuanbiao, and L. Yuanyuan, Studies on preparation of Ti₃SiC₂ particulate reinforced Cu matrix composite by warm compaction and its tribological behavior, Materials Science Forum 534-536 (2007) 929-32; T. L. Ngai, L. Yuanyuan, and Z. Zhaoyao, A study on Ti₃SiC₂ reinforced copper matrix composite by warm compaction powder metallurgy, Materials Science Forum 532-533 (2007) 596-9, all incorporated herein by reference) that were mainly fabricated by warm compaction with high strengths, conductivities and good tribological properties. Herein, the processing and microstructural characterization of Ti₂AlC/Mg composites is disclosed.

To manufacture composites with optimum properties, the manufacturing process preferably assures a uniform distribution of the reinforcing phase in the matrix. A variety of magnesium matrix composites have been fabricated through powder metallurgy. Stir casting is also suitable for manufacturing composites with up to 30% volume fractions of reinforcement with further extrusion to reduce porosity, refine the microstructure, and homogenize the distribution of the reinforcement. Squeeze infiltration and spontaneous infiltration of magnesium matrix composites have also been reported.

The advantages of infiltration techniques include the capability of incorporating a relatively high volume fraction of reinforcement and fabrication of composites with matrix alloy and reinforcement systems that are otherwise immiscible by other techniques. The melt infiltration (MI) technique utilized herein not only resulted in homogenous microstructures, but is a low cost technique that can be readily scaled up.

The microstructure of a mounted and polished MI sample—with 50 vol. % Mg—was quite homogeneous and apparently dense (FIG. 8a). The Ti₂AlC grain size is 20±10 μm. The density, measured by Archimedes's principle, is 2.87±0.05 Mg/m³. The fractured surface, (FIG. 8b), however, showed the presence of sub-micron Mg single crystals (pointed to by arrows). Interestingly, similar, but much larger, single crystals were formed on the surfaces of the Al₂O₃ lids on the crucibles used to keep the Mg from evaporating. It follows that they were likely formed by an evaporation/condensation process.

When the same sample is imaged in a TEM (FIGS. 9a and 9b) it is obvious that, for the most part, the molten Mg has wet the Ti₂AlC and infiltrated the preform. However, consistent with FIG. 8b, some small pockets where the Mg appears in the form of nanosized single crystals (FIG. 9a) were observed. At higher magnifications (FIGS. 9c and 9d) it is evident that the molten Mg matrix solidified in the form of nano-crystals, roughly 20 nm in diameter. To confirm this surprising result, the full-widths at half maximum, FWHM, of XRD Mg peaks in the composite were compared with those of pure Mg powder (dₐᵥ≈150 μm), Mg single crystals and Si. The results (FIG. 10) confirm that the former are significantly broader. Using the Scherrer formula, the particle size was estimated to be ˜35±15 nm. Annealing at 550° C. for six hours did not result in significant grain growth as evidenced by the FWHM of the Mg-peaks after annealing. This thermal stability, even after 1 h soaking at 750° C.—i.e. 100° C. higher than the melting point of Mg—in the vacuum chamber of a graphite heated hot press, is another surprising characteristic of these nano-grains. This implies the presence of a potent grain-growth inhibitor. The presence of MgO peaks in the XRD spectra strongly suggests that MgO phase plays that role. Based on the FWHM of the MgO peaks (FIG. 10) its grain size is estimated to be of the order of ˜3±1 nm.

Energy Dispersive X-Ray Spectroscopy (EDS) in the TEM of the Mg matrix in several regions similar to those shown in FIG. 9 confirmed the presence of Mg, Ti and O. EDS microanalysis of the Mg matrix in the SEM revealed the presence of ˜3±1 at. % Ti. Based on the results, Ti diffuses out of the Ti₂AlC grains into the Mg matrix. Given that Ti is a potent heterogeneous nucleation agent, it is not unreasonable to assume that it is responsible for the formation of the Mg nano-crystals. It is important to note, however, that according to the Mg—Ti binary phase diagram the solubility of Ti in Mg at 750° C. is negligible. The absence of pure Ti regions in the TEM, however, suggests that the Ti is supersaturated in the Mg matrix.

EDS microanalysis of the Ti₂AlC grains in the TEM and SEM revealed the presence of Mg within them (FIG. 11a). The sum of Mg and Ti concentrations at various distances from the grain edges was 50 at. %. It follows that the solubility of Mg in Ti₂AlC is non-negligible. In other words, the solid solution (Ti₁₋ₓMgₓ)₂AlC in which x is as high as 0.2, exists. Due to the fairly low Mg-content, its effect on the c-lattice parameter of Ti₂AlC grains is small and, within experimental scatter, identical to the as-received powders (FIG. 11b). The increase in a-lattice parameter, on the other hand, is non-trivial and can be attributed with the larger radius of Mg in comparison with Ti. Note the values reported herein are most probably not equilibrium values.

The diffusion coefficient of Mg in Ti₂AlC at 750° C. is estimated (x²/Dt, where x is the distance from Mg/Ti₂AlC interface and t is the diffusion time) to be ≈3×10⁻¹⁶ m²/s.

The ultimate tensile strength (UTS) of the composite was measured to be ˜345±40 MPa. This strength is in line with Mg alloy matrix composites such as AZ91 reinforced with SiC (320 MPa), Al₂O₃ (310 MPa) and TiB₂ (340 MPa) or even significantly higher than pure Mg matrix composites reinforced with 10-30 vol. % SiC_{P} (217-280 MPa). Also the UTS measured herein is comparable with Al-40% SiC_{P} (390 MPa) composites.

### Visual Analysis

The microstructures of the polished HP and MI samples were quite homogeneous and apparently dense. The highest density of 2.87±0.03 Mg/m³ (˜98.5% of theoretical) in the HP composites was only obtained when the Mg content was 50 vol. % (HP50). At 40 vol. % Mg the density was 85% of theoretical (HP40). Lower Mg contents resulted in more porous samples that were not studied further. The theoretical density was calculated assuming the densities of Mg and Ti₂AlC to be 1.74 Mg/m³ and 4.11 Mg/m³ respectively. At 2.87±0.05 Mg/m³, the densities of the Mg-50 vol. % Ti₂AlC MI samples were also 98.5% of theoretical.

FIGS. 2a and 2b show the secondary electron SEM images of polished surface of the MI-P and MI-N, samples, respectively. Clearly, the manual vibration (pursuant to the melt infiltration procedure described herein) of the flaky powder prior to cold pressing oriented many of the grains. Most of the grains' basal planes are perpendicular to the surface in the MI-N composite (FIG. 2b). Table 4, below, provides the ratio of XRD peak intensities of (002) basal planes and (103) & (104) planes in MI-R, HP, MI-P, MI-N, Ti₂AlC, Ti₃SiC₂ and Mg-312 composites.

TABLE 4

| | Material | | | | | |
|---|---|---|---|---|---|---|
| | | | | | Ti₂AlC | Ti₂AlC |
| | HP | MI-R | MI-P | MI-N | Powder | (XRD Card) |
| I (002)/I (103) | 0.32 ± 0.02 | 0.25 ± 0.07 | 0.29 ± 0.04 | 0.20 ± 0.01 | 0.52 ± 0.04 | 0.39 |

| | Material | | | | |
|---|---|---|---|---|---|
| | Mg-312 | Mg-312 | Mg-312 | Ti₃SiC₂ | Ti₃SiC₂ |
| | Random | (Parallel) | (Normal) | Powder | (XRD Card) |
| I (002)/I (104) | 0.16 ± 0.03 | 1.0 ± 0.1 | 0.25 ± 0.06 | 0.35 ± 0.06 | 0.20 |

From X-ray diffraction, the ratios of (002) to (103) planes' peak intensities of the Ti₂AlC phase in the MI-R and oriented MI samples at two different orientations as mentioned earlier (i.e., MI-P and MI-N), HP sample and those of Ti₃SiC₂ and Mg-312 composites were compared (Table 4). Evidently, this ratio in the MI-P orientation was greater than the MI-N orientation and MI-R falls in between, further proof for the preferred orientation of the basal planes in MI-P and MI-N composite samples. Surprisingly, however, comparison of this ratio in the composites with powder diffraction file of Ti₂AlC and the as-received Ti₂AlC powder reveals that it is noticeably higher in the latter two cases (Table 4). To confirm the accuracy of the results, XRD was performed on Ti₂AlC powder that was tapped and gently pressed in a steel die, and it was observed that the ratio of the (002) to (103) planes' peak intensities dramatically increased to a value of ˜1.25; OM micrographs of etched, fully dense bulk Ti₂AlC (FIG. 3a) and Ti₃SiC₂ samples (FIG. 3b) show that while the Ti₂AlC grains are plate-like, the Ti₃SiC₂ grains are more equiaxed. Although it was postulated that this difference in initial grain morphologies of the Ti₂AlC and Ti₃SiC₂ powders may increase the orientability of the former, XRD results (Table 4) unexpectedly proved otherwise.

Similar to all other MAX phases and Mg, both HP and MI composites are readily machinable even with a manual hack-saw with no lubrication or cooling. They can also readily be subjected to Electron Discharge Machining (EDM) with a significantly higher rate and ease than the MAX phases. Their machinability is similar to 7000 series Al alloys.

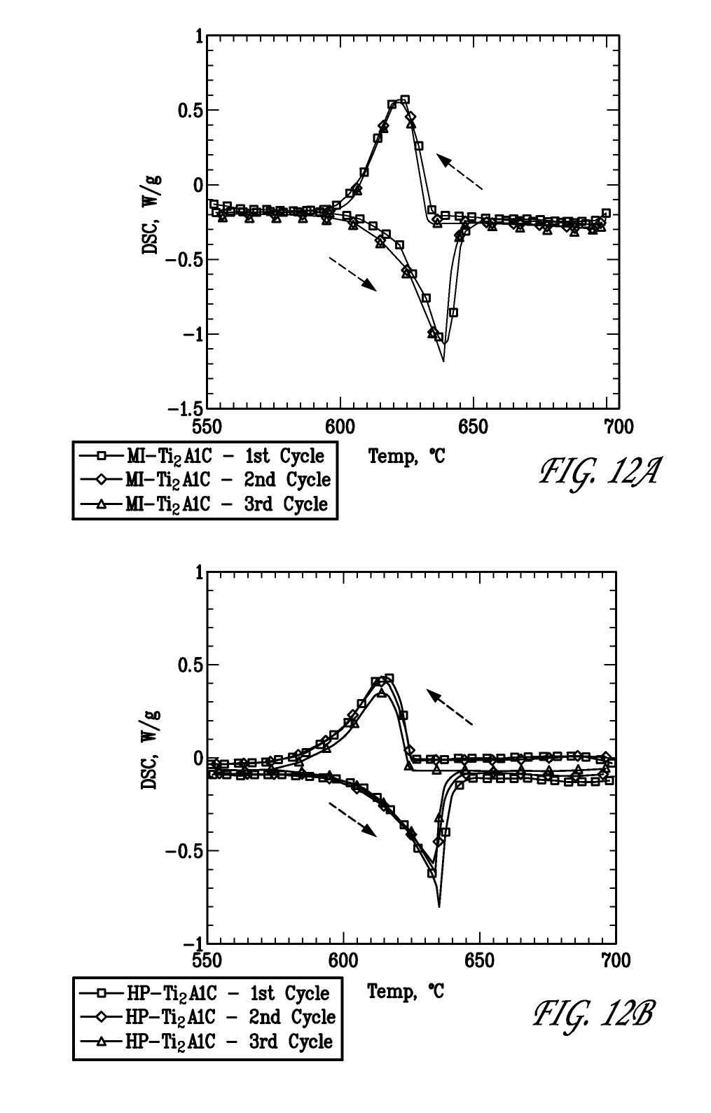

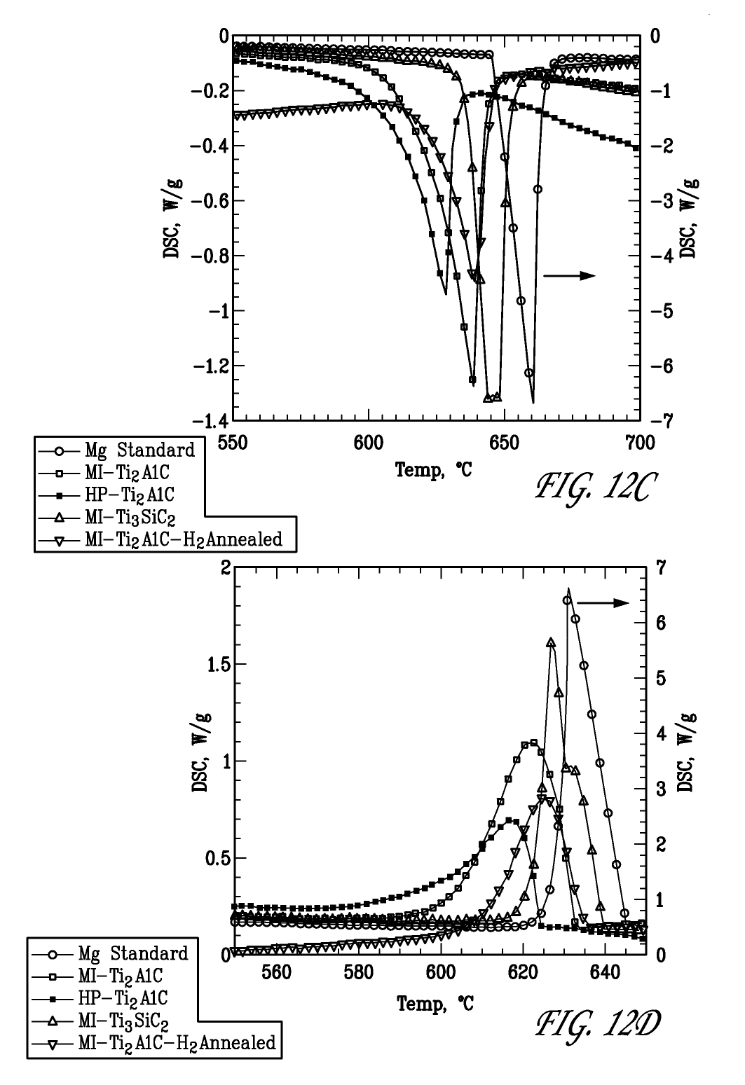

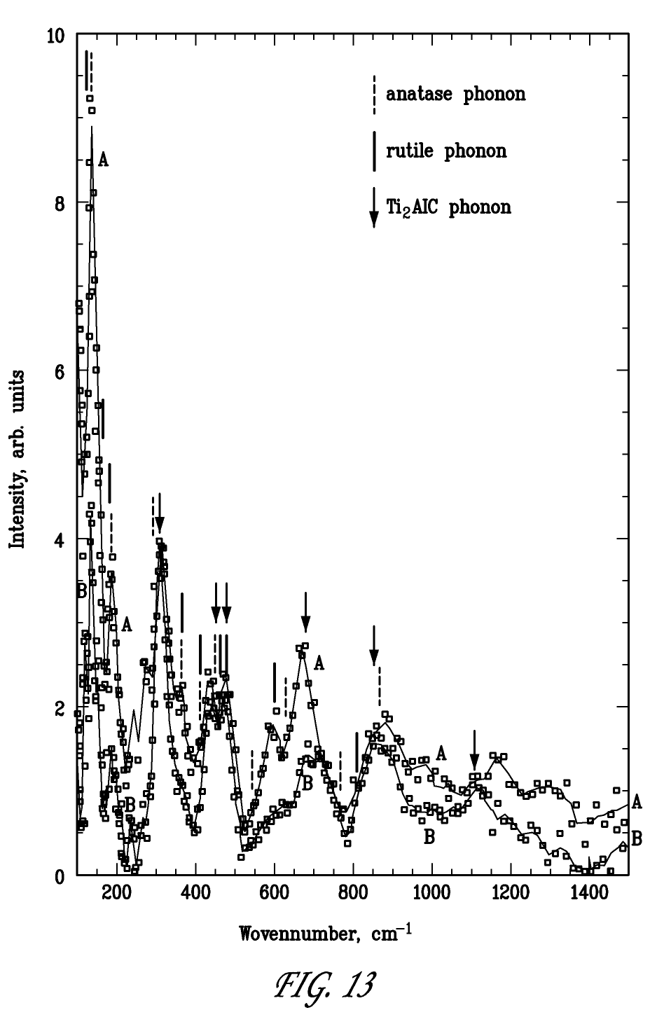

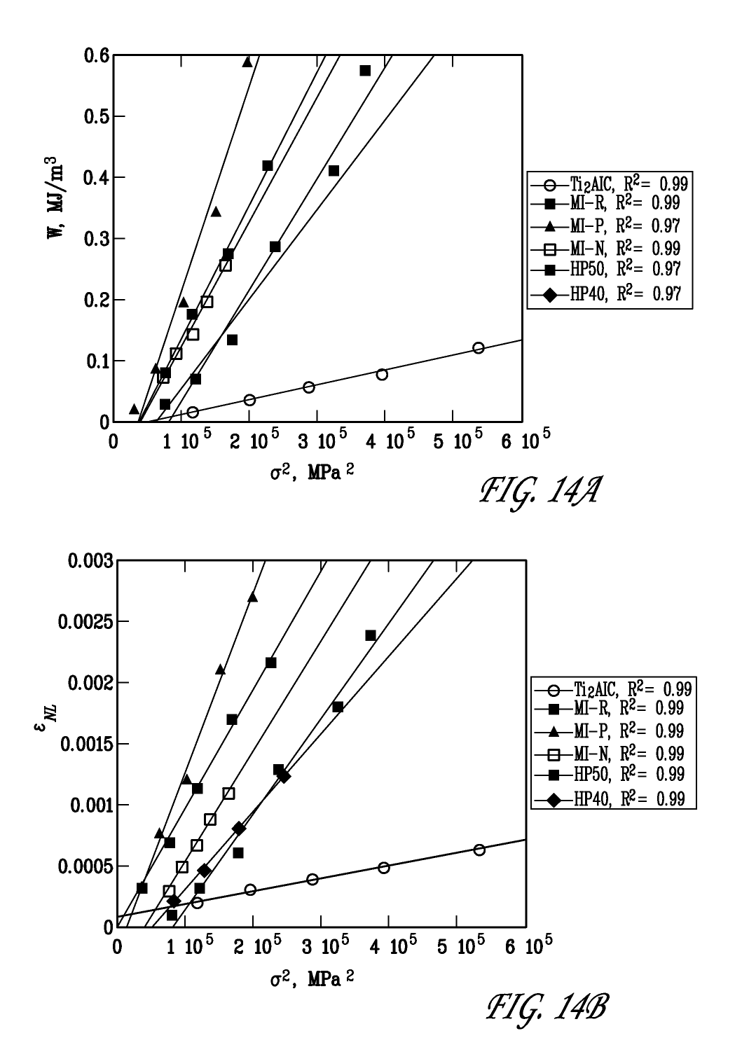

The effect of indentation loads on the V_{H} values of the HP, MI-R, MI-P and MI-N samples, together with those of fully dense Ti₂AlC, pure Mg, Mg-312 and Mg—SiC for the sake of comparison are plotted in FIG. 4. Inset in FIG. 4 shows a secondary electron SEM image of a Vickers indentation mark in the MI composite. A similar mark (not shown) was observed for the HP sample.

### Compressive Attributes

FIG. 5 shows the compressive strength of several tested materials. HP50 refers to Mg-50 vol. % Ti₂AlC composite fabricated by hot pressing (HP) where the Mg matrix appeared in the form of nano-crystalline grains (about 15-30 nm) confirmed by both XRD and TEM, just like MI50 composite. Mg—SiC also refers to Mg-50 vol. % SiC composite fabricated by hot pressing and last is Mg-50 vol. % Ti₃SiC₂ composite fabricated by melt infiltration. Lack of presence of nano-crystalline Mg grains in the latter two composites was also confirmed by XRD and TEM, which is a unique indication of the effect of Mg nano-crystallinity on mechanical properties of these composites. As it can be observed from FIG. 5, due to the presence of nano-crystalline Mg in both HP50 and MI50 composites, there is only 7 and 19% decrease in the compressive strength as compared to their monolithic counterparts (Ti₂AlC), respectively. For cyclic compression tests, typically five cycles are obtained at each load. For the most part, the first cycles were very slightly open, registering a plastic strain of the order of 0.05%. However, all subsequent cycles, to the same stress, were closed and exceptionally reproducible, which is why in FIG. 7 only one loop at any given stress is plotted.

FIG. 7 depicts the compressive stress-strain curves of, a) MI-N, b) MI-P, c) MI-R, d) Mg—SiC and Mg-312, e) HP40 and f) HP50 composites; only one cycle per load is shown and the curves are shifted horizontally for clarity. Cylinders for compression tests parallel and normal to the cold-pressing direction were subjected to Electron Discharge Machining (EDM) from the oriented infiltrated preforms. Under compression, the basal planes in the former are normal, or edge-on, to the loading direction, which is why these samples are herein referred to as “MI-N”. When the basal planes are parallel to the loading direction, the samples are herein referred to as “MI-P”. This nomenclature is also valid for the Vickers hardness measurements because in the MI-N sample, the indenter is normal to the basal planes, et cetera. The randomly oriented samples will be referred to as MI-R. For clarity's sake, in most of the stress-strain figures, a small schematic of the relationship of the basal planes to the applied load is shown as an inset.

Also for the sake of comparison, Mg-50 vol. % Ti₃SiC₂ and Mg-50 vol. % SiC composites were fabricated by hot pressing. In this case, the starting powders were Ti₃SiC₂ (−325 mesh, 3-ONE-2, Voorhees, N.J.), SiC (−325 mesh, Alfa Aesar, Ward Hill, MA) and the same Mg powder used above. The processing details were identical to those of the Mg—Ti₂AlC(HP) composites described below in Example 7. These samples will henceforth be referred to as “Mg-312” and “Mg—SiC”, respectively.

Bulk Ti₂AlC and Ti₃SiC₂ samples were also made by hot isostatic pressing (HIP) for the sake of comparison. The starting powders were sealed in rubber bags under a mechanical vacuum and were cold isostatically pressed (CIPed) to ˜250 MPa for 5 min. The samples were then placed in a hot isostatic press (HIP), heated to 750° C. at a rate of 5° C./min, at which time the chamber was pressurized with Ar gas to ˜100 MPa. The heating was then resumed at a rate of 10° C./min to 1400° C. at which time the chamber was further pressurized to 175 MPa and the samples were held for 2 h followed by furnace-cooling to room temperature.

The composite samples' microstructures were observed in a field emission scanning electron microscope, SEM, (Zeiss Supra 50VP, Germany) after cross-sectioning, mounting and polishing with a diamond solution down to 1 μm. The bulk Ti₃SiC₂ and Ti₂AlC samples also polished and etched for ˜10 s with a 1:1:1 (volume) H₂O:HNO₃:HF etchant solution and their microstructures were then observed with an optical microscope, OM, (Olympus PMG-3, Tokyo, Japan). The oriented composite samples were cross-sectioned parallel and normal to the plate-like-grains in order to image the morphology in both directions (MI-P and MI-N).

Bulk composite samples were placed in a diffractometer (Model 500D, Siemens, Karlsruhe, Germany) and their spectra were collected using Cu Kα radiation (40 KV and 30 mA) and step scans of 0.01 2θ and a step time of 2 s.

The Vickers microhardness values, V_{H}, —measured using a microhardness indenter (LEC0-M400, LECO Corp. St. Joseph, Mich.)—were determined by averaging at least 10 measurements at 1, 2, 3, 5 and 10 N. The hardness measurements were carried out on the MI (MI-R, MI-P and MI-N) and HP composites, pure polycrystalline Mg, dense Ti₂AlC, Mg—SiC and Mg-312 composites for the sake of comparison.

The room temperature ultimate compressive stresses, UCS, were measured using a hydraulic testing machine (MTS 810, Minneapolis, Minn.) on small 3×3×3 mm³ electron discharged machined, EDMed, cubes. Six samples were tested (results reported in FIG. 5).

EDMed cylinders 9.7 mm in diameter and 31 mm high were used to measure the Young's moduli in compression and to carry out the cyclic uniaxial compression tests. In all cases, the strains were measured by a capacitance extensometer (MTS, Minneapolis, Minn.)—attached to the samples—with a range of 1% strain. All the loading-unloading compression tests were performed in load-control mode at a loading-unloading rate of 15 MPa/s, respectively, which corresponds to a strain rate of 2×10⁻⁴ s⁻¹.

Typical stress-strain loops at various stresses for the MI-P (FIG. 7a), MI-N (FIG. 7b) and MI-R (FIG. 7c)—loaded to roughly ˜75% of their UCS—at different stresses are all closed. Typical fully reversible stress-strain loops for the Mg-312 and Mg—SiC composites (FIG. 7d) are, however, significantly smaller than the rest. FIGS. 7e and 7f show typical fully reversible stress-strain loops of HP50 and HP40 composites, respectively.

To obtain an approximate “effective” Young's modulus, E, least squares fits of the entire data set that resulted in diagonal lines bisecting the loops (only those at the highest load are shown in figures) were carried out at each stress. The results are summarized in Table 5, below.

TABLE 5
Effective Young's modulus, Ē, for MI-P, MI-R, MI-N, HP50,
HP40, Mg-312, Mg—SiC, Ti₂AlC and Ti₃SiC₂ samples tested herein

| Material | MI-P | MI-R | MI-N | HP50 | HP40 | Mg-312 | Mg—SiC | Ti₂AlC | Ti₃SiC₂ |
|---|---|---|---|---|---|---|---|---|---|
| Ē (GPa) | 69 ± 10 | 72 ± 6 | 74 ± 3 | 88 ± 5 | 83 ± 5 | 74 ± 4 | 117 ± 17 | 218 ± 6 | 237 ± 22 |

Apparently, MI-N exhibited slightly higher Ē compared to MI-P because in the least squares fits method, as the loops become larger the values of Ē become smaller, that in turn contributes to lower Ē in MI-P composite. Clearly, E is a function of kinking and depends on the size and extent of the hysteresis stress-strain curves.

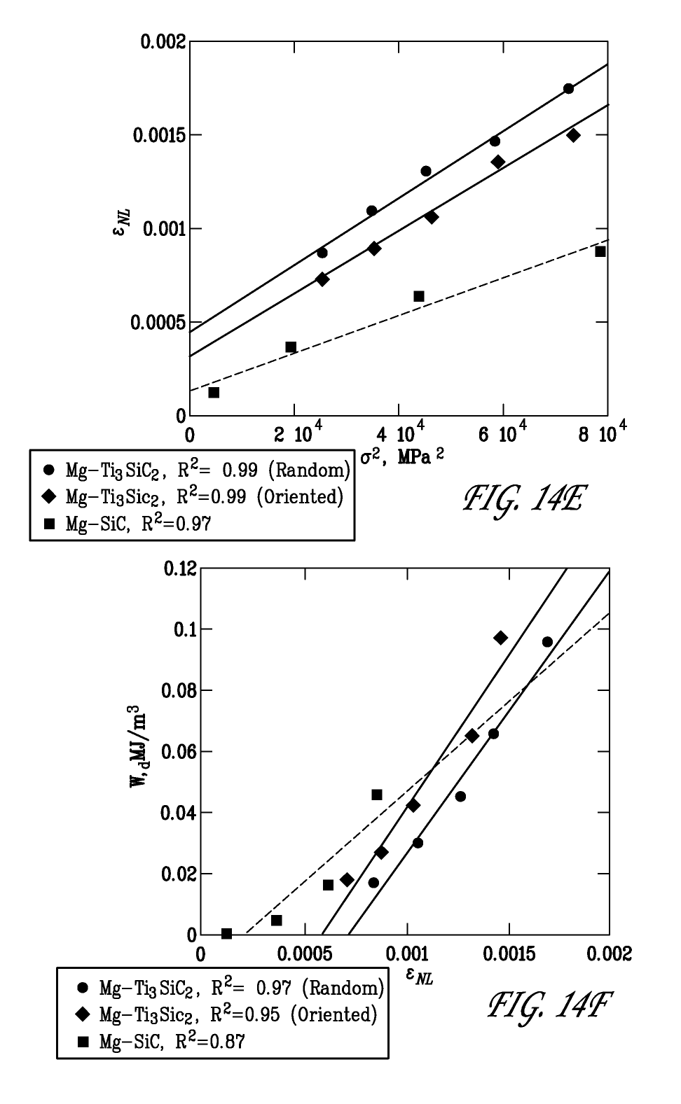

The Ē of the Mg-312 composites seems to be very close to Mg—Ti₂AlC ones. Although Ti₃SiC₂ is stiffer than Ti₂AlC (note Ē values of 237 vs. 218 GPa in Table 5, and also Ē values of 343 vs. 277 GPa reported in the literature) but the equity of Ē in their corresponding Mg composites is most likely due to the effect of Mg nanograins in the Mg—Ti₂AlC system and lack thereof in Mg-312 composites. Mg—SiC composite, on the other hand, exhibited the largest value in Ē believed to be due to the higher modulus of elasticity of SiC (˜475) and the very small size of stress-strain loops associated with Mg—SiC composite (FIGS. 7d and 14d).

### KNE Model

It has been recently been postulated that most plastically anisotropic solids with c/a ratios >1.5 belong to the same class of solids we labeled kinking nonlinear elastic (KNE). Kinking is a mechanism first reported by E. Orowan in single crystals of Cd loaded parallel to the basal planes. Kink band formation is the key mechanism without which the deformation of KNE solids cannot be understood. Recently, it has been established that a number of seemingly unrelated solids such as graphite, mica, sapphire, ZnO, GaN, LiNbO₃ and hexagonal metals (Mg, Co, Ti, Zn, inter alia), among many others, are also KNE solids. More importantly, it was also shown that MAX-reinforced metal-matrix composites are KNE solids as well (S. Amini, C. Ni, M. W. Barsoum, Composites Science and Technology 2009, 69, 414, incorporated herein by reference).

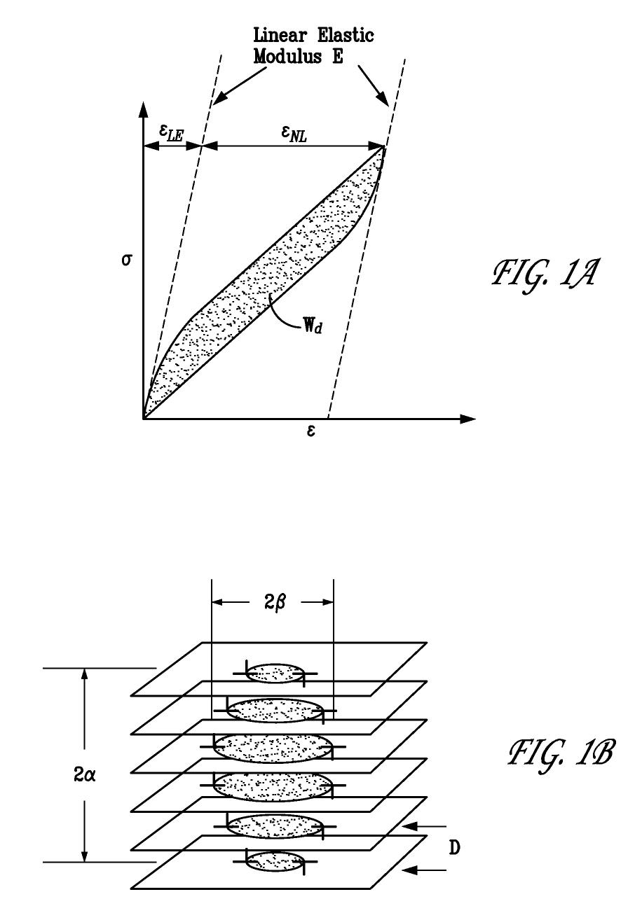

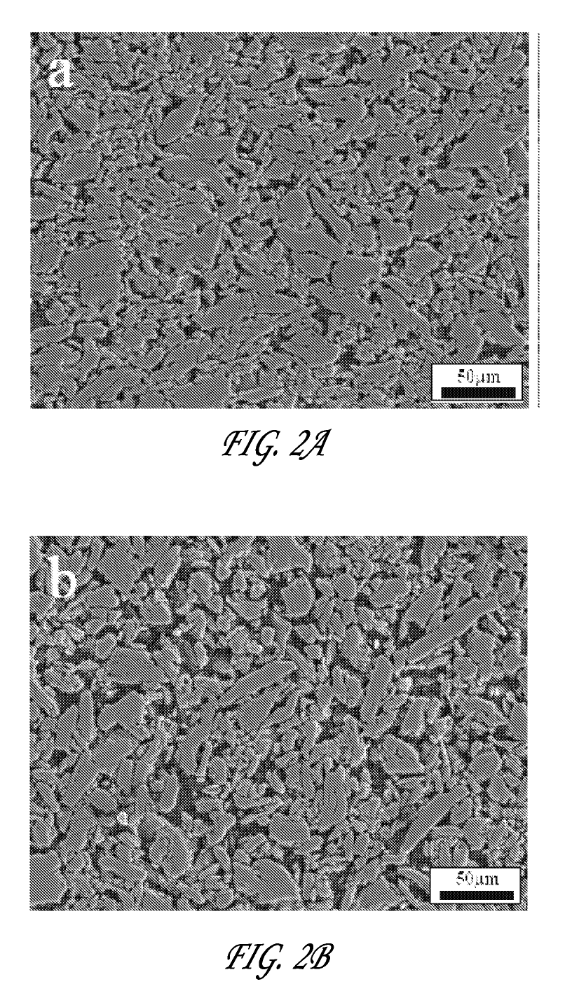

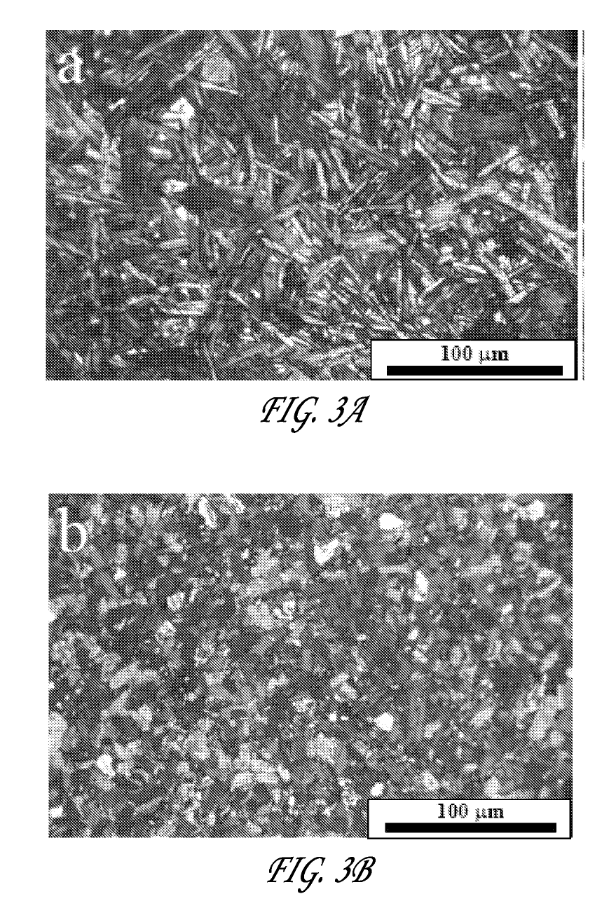

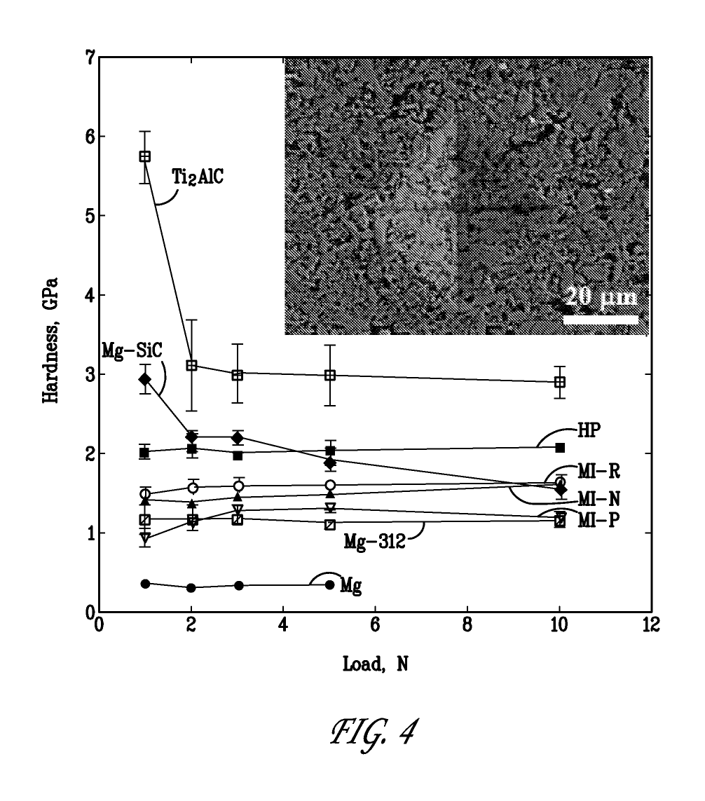

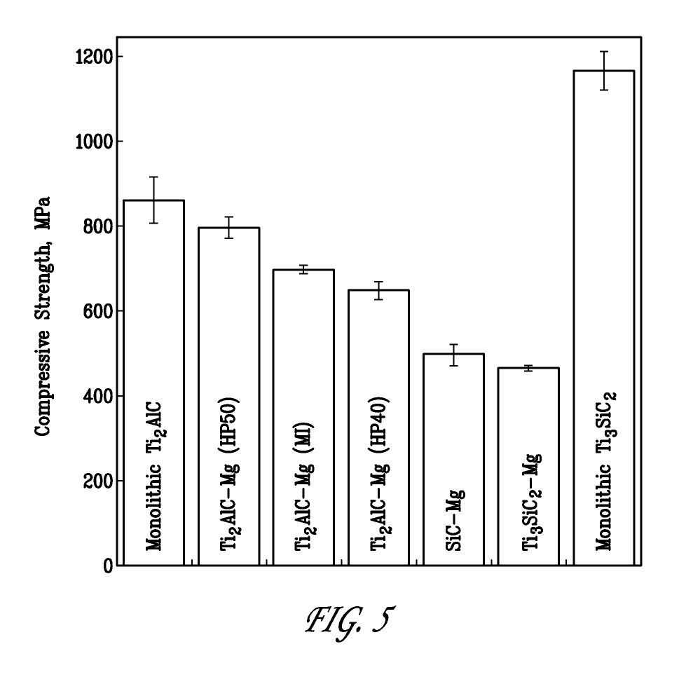

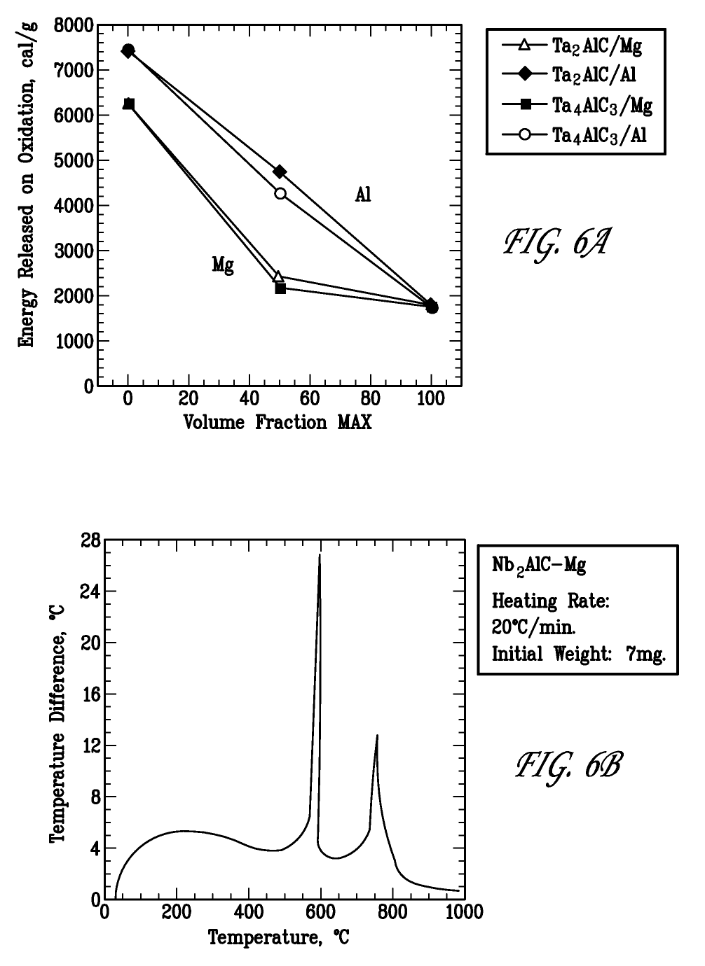

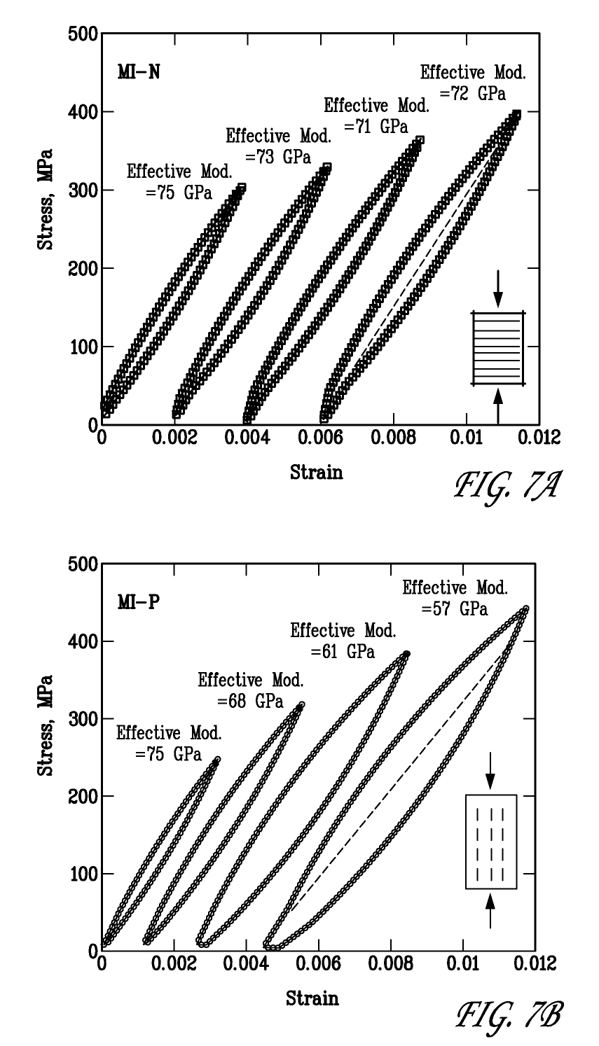

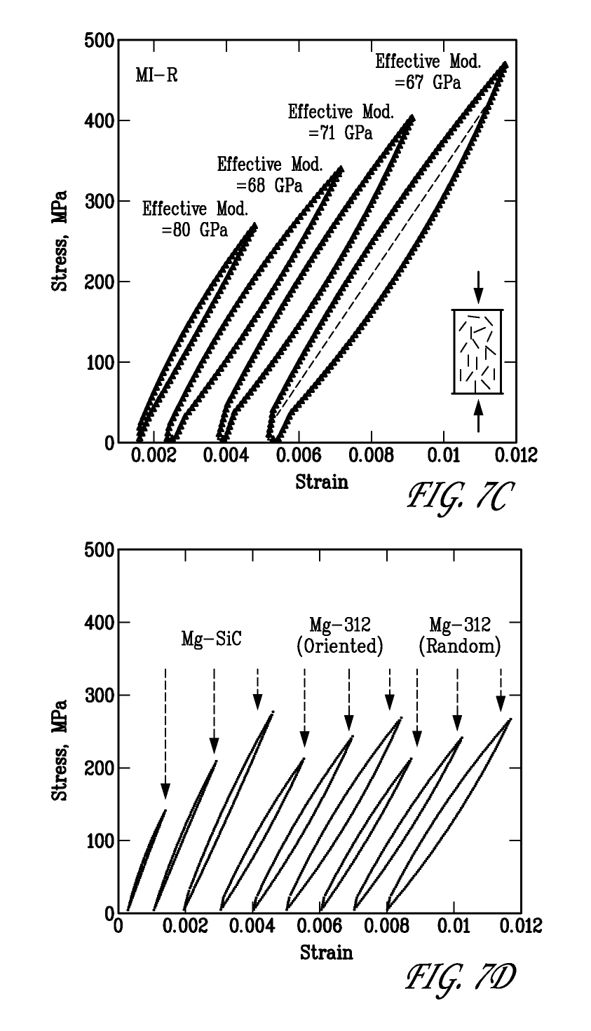

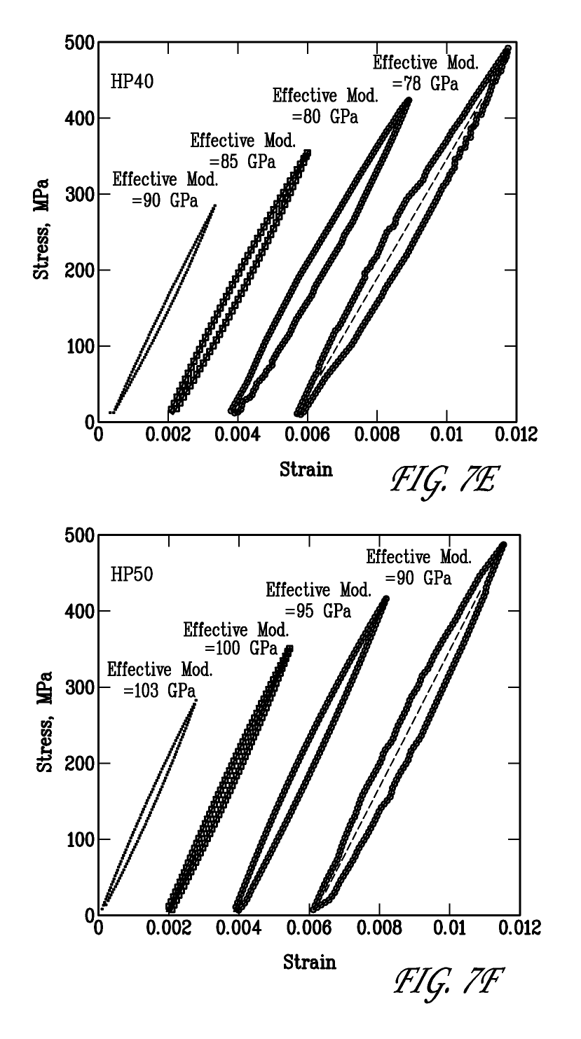

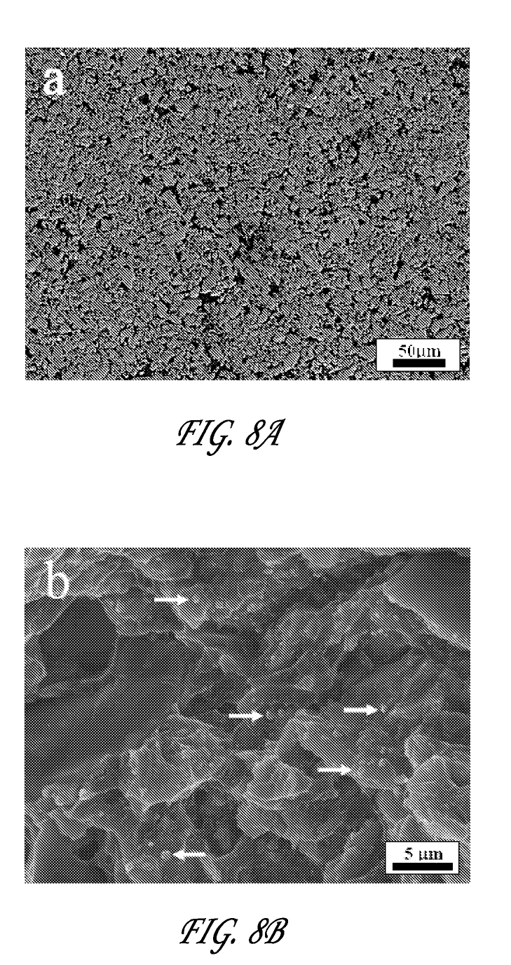

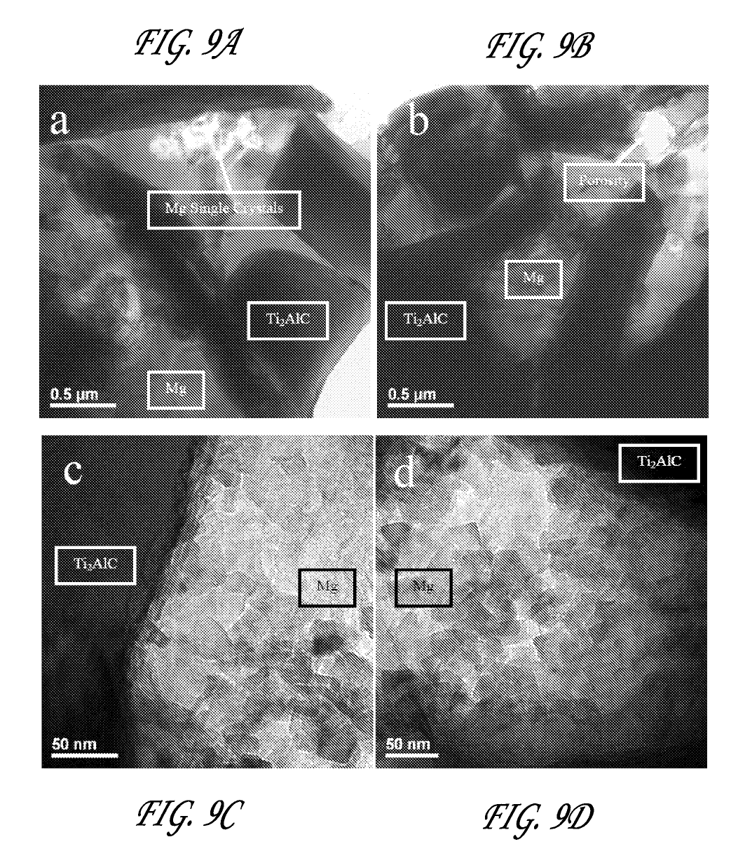

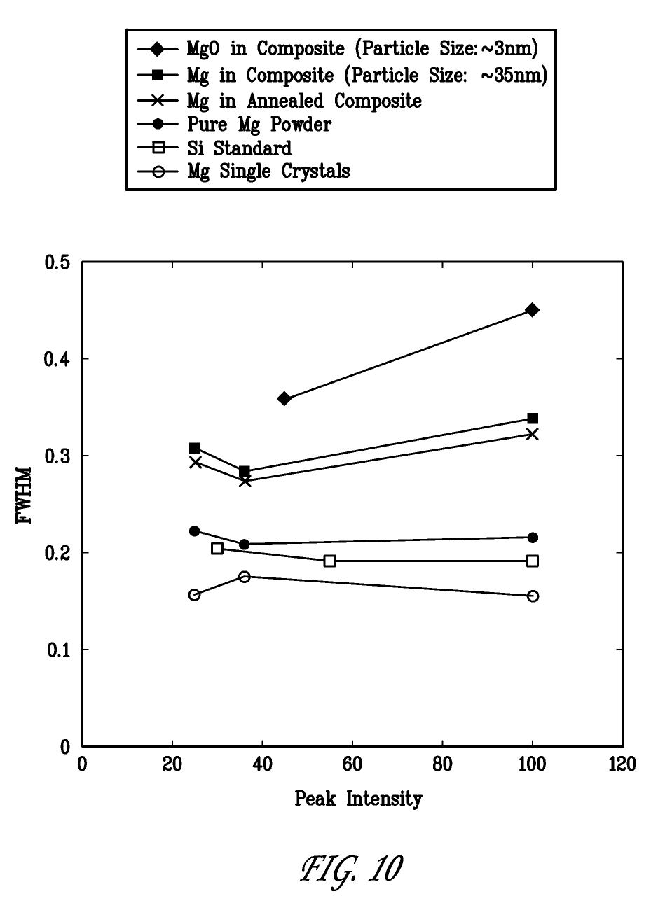

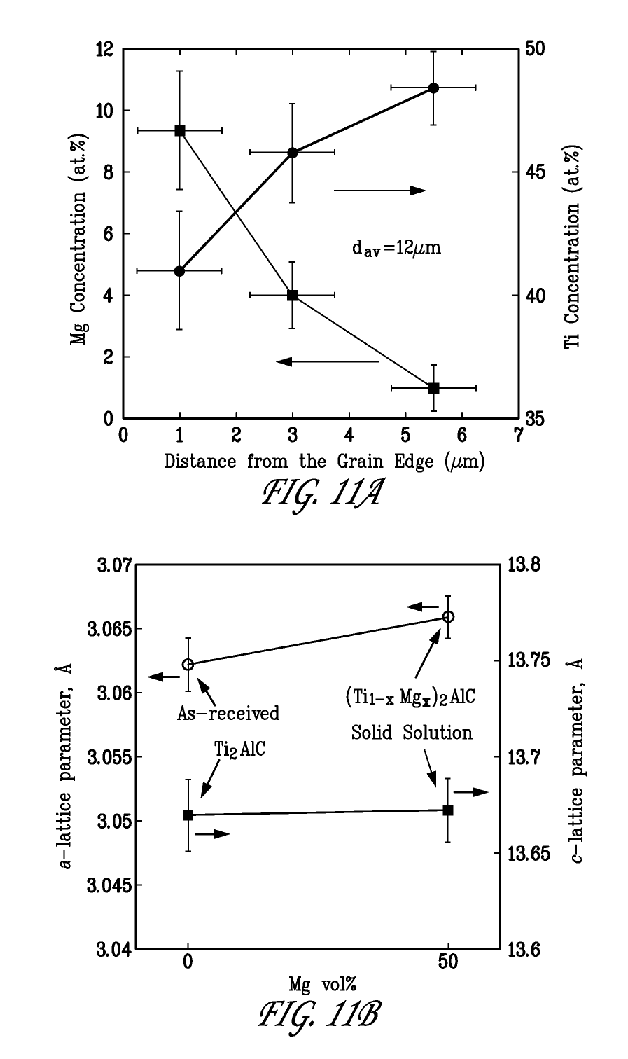

The signature of KNE solids is the formation of fully reversible, hysteretic stress-strain loops (FIG. 1a) during cyclic loadings. This full reversibility has been attributed to the formation of incipient kink bands (IKBs) that are comprised of multiple, parallel dislocation loops (FIG. 1b), whose shape ensures that when the load is removed they shrink significantly or are annihilated altogether. In other words, solids that are highly plastically anisotropic deform at least initially by the formation of dislocation-based IKBs

Pursuant to the present invention, a microscale model was developed for the deformation behavior of KNE solids that is based on the work of Frank and Stroh (F. C. Frank, A. N. Stroh, Proc. Phys. Soc. 1952, 65, 811; hereafter, “F&S”, incorporated herein by reference).

In what follows, a simplified version is presented. Frank and Stroh considered an elliptic kink band, KB, with length, 2α, and width, 2β, such that α>>β (FIG. 1a) and showed that the remote shear stress, τ, needed to render such a subcritical KB unstable is given by:

$$τ > {τ}_{t} \approx \frac{{σ}_{t}}{M} \approx \sqrt{\frac{4 {G}^{2} b {γ}_{c}}{2 α {π}^{2}} ln ( \frac{b}{{γ}_{c} w} )} \qquad ( 1 )$$

where τₜ, and σₜ are the remote critical shear and axial stresses; M is the Taylor factor relating them; G is the shear modulus and b is the Burgers vector; w is related to the dislocation core width. The grain dimension has been equated along the [0001] direction—i.e., normal to the direction of easy slip—with 2α. If σₜ—that is an experimentally determinable threshold stress—is known, then 2α can be estimated from Eq. 1; γ_{c} is critical kinking angle calculated assuming

$${γ}_{c} = \frac{b}{D} \approx \frac{3 \sqrt{3} ( 1 - v )}{8 π e} ( \frac{b}{w} ) \qquad ( 2 )$$

where v is Poisson's ratio, and D is the distance between dislocation loops along 2α (FIG. 1a). Because an IKB supposedly consists of multiple parallel dislocation loops (FIG. 1a), as a first approximation we assume each loop is comprised of two edge, and two screw dislocation segments with lengths, 2βₓ and 2β_{y}, respectively. The latter are related to the applied stress, σ and 2α assuming:

$$2 {β}_{x} \approx \frac{2 α ( 1 - v )}{G {γ}_{c}} \frac{σ}{M} and 2 {β}_{y} \approx \frac{2 α}{G {γ}_{c}} \frac{σ}{M} \qquad ( 3 )$$

The formation of an IKB can be divided into two stages: nucleation and growth. Since the former is not well understood, our model only considers IKB growth from 2β_{xc} and 2β_{yc} to 2βₓ and 2β_{y}, respectively. The dislocation segment lengths of an IKB nucleus, β_{xc} and 2β_{yc}, are presumed to pre-exist, or are nucleated during pre-straining. The values of 2β_{xc} and 2β_{yc} are estimated from Eqs. 3, assuming σ=σₜ, where the latter is experimentally obtained (see below).

It follows that for σ>σₜ, the IKB nuclei grow and the IKB-induced axial strain resulting from their growth is assumed to be given by:

$$\begin{matrix}{ɛ}_{IKB} = \frac{Δ {VN}_{k} {γ}_{c}}{{k}_{1}} \\ = \frac{{N}_{k} {γ}_{c} 4 π α ( {β}_{x} {β}_{y} - {β}_{c , x} {β}_{c , y} )}{3 {k}_{1}} \\ = \frac{4 π ( 1 - v ) {N}_{k} {α}^{3}}{3 {k}_{1} {G}^{2} {γ}_{c} {M}^{2}} ( {σ}^{2} - {σ}_{t}^{2} ) \\ = {m}_{1} ( {σ}^{2} - {σ}_{t}^{2} )\end{matrix} \qquad ( 4 )$$

where m₁ is the coefficient before the term in brackets in the fourth term; Nₖ is the number of IKBs per unit volume; ΔV is the volume change due to one IKB as the stress is increased from σₜ to σ. It follows that the product VₓNₖ=v_{f}, is the volume fraction of the material that is kinked. The factor k₁ relates the volumetric strain due to the IKBs to the axial strain along the loading direction, assumed to be 2.

The energy dissipated per unit volume per cycle, W_{d}, (shaded area in FIG. 1b) resulting from the growth of the IKBs from β_{i,c} to βᵢ is given by:

$$\begin{matrix}{W}_{d} = \frac{4 Ω π {N}_{k} α}{D} ( {β}_{x} {β}_{y} - {β}_{xc} {β}_{yc} ) \\ = \frac{4 π ( 1 - v ) {N}_{k} {α}^{3}}{{G}^{2} {γ}_{c} {M}^{2}} \frac{Ω}{b} ( {σ}^{2} - {σ}_{t}^{2} ) \\ = {m}_{2} ( {σ}^{2} - {σ}_{t}^{2} )\end{matrix} \qquad ( 5 )$$

Ω is the energy dissipated by a dislocation line sweeping a unit area. Thus, Ω/b should be proportional, if not equal, to the critical resolved shear stress, CRSS, of an IKB dislocation loop.

Combining Eqs. 4 and 5 yields:

$${W}_{d} = 3 {k}_{1} \frac{Ω}{b} {ɛ}_{IKB} = \frac{{m}_{2}}{{m}_{1}} {ɛ}_{IKB} \qquad ( 6 )$$

Experimentally one can determine σₜ and

$$3 {k}_{1} \frac{Ω}{b} .$$

Hence, the estimation of Ω/b only requires knowledge of k₁ in Eq. 6. Thus, once the nested loops are obtained (e.g., FIG. 7) and the plots shown in FIGS. 14a-c are plotted, Eq. 6 is used to estimate Ω/b, assuming k₁=2. Experimentally, m₂ can be determined from the slopes of W_{d} vs. σ² plots (e.g., FIG. 14a). It follows that if our assumptions are correct, and more importantly, if the micromechanism that is causing the dependence of ε_{NL} on σ (i.e., Eq. 5) is the same as the one responsible for W_{d} (Eq. 6), then the ratio m₂/m₁ should equal 3k₁Ω/b. In other words, if both expressions give the same values for Ω/b that would be strong evidence that our assumptions are correct and more importantly, the same micromechanism that results in the parabolic dependence of σ on ε_{NL}, is the one responsible for W_{d} as well.

Lastly, assuming the IKBs are cylinders with radii βₐᵥ, then the reversible dislocation density, ρᵣₑᵥ, due to the IKBs is given by:

$${ρ}_{rev} = \frac{2 π {N}_{k} 2 α {β}_{av}}{D} = \frac{4 π {N}_{k} α {β}_{av} {γ}_{c}}{b} \qquad ( 7 )$$

where βₐᵥ is the average of β_{vc} and β_{yc}.

Based on the KNE model, the mechanical hysteresis of a KNE solid can be characterized by three parameters, σ, ε_{NL} and W_{d}, listed in Table 6 (below) for MI-P, MI-R, MI-N, HP50, HP40, Mg—SiC, Mg-312 and randomly oriented Ti₂AlC and Ti₃SiC₂ samples tested herein, all obtainable from their corresponding hysteretic stress-strain curves (FIGS. 7a-f). Table 6 (below) provides a list of measured stress (σ), nonlinear strain (ε_{NL}), and dissipated energy (W_{d}) for MI-P, MI-R, MI-N, HP50, HP40, Mg—SiC, Mg-312 and randomly oriented Ti₂AlC and Ti₃SiC₂ samples tested herein. Also listed are the m₁, m₂ and their ratio and 3k₁Ω/b values obtained from the slopes of ε_{NL} vs. σ², W_{d} vs. σ² and W_{d} vs. ε_{NL} plots.

TABLE 6

| | σ | | W_{d} | M₁ | m₂ | m₂/m₁ | 3k₁Ω/b |
|---|---|---|---|---|---|---|---|
| | MPa | ε_{NL} | MJ/m³ | (MPa)⁻² | (MPa)⁻¹ | (MPa) | (MPa) |
| MI-P | 250 | 0.0007 | 0.0832 | 1.5 × 10⁻⁸ | 3.4 × 10⁻⁶ | 230 | 229 |
| | 319 | 0.0012 | 0.1922 | | | | |
| | 388 | 0.0021 | 0.3443 | | | | |
| | 445 | 0.0027 | 0.585 | | | | |
| MI-R | 275 | 0.0007 | 0.0795 | 9.8 × 10⁻⁹ | 2.2 × 10⁻⁶ | 225 | 223 |
| | 340 | 0.0011 | 0.1755 | | | | |
| | 410 | 0.0017 | 0.2752 | | | | |
| | 475 | 0.0021 | 0.4171 | | | | |
| MI-N | 305 | 0.0005 | 0.1101 | 9.0 × 10⁻⁹ | 2.0 × 10⁻⁶ | 225 | 224 |
| | 338 | 0.0007 | 0.144 | | | | |
| | 370 | 0.0009 | 0.1962 | | | | |
| | 405 | 0.0011 | 0.2573 | | | | |
| HP50 | 280 | 0.0001 | 0.0324 | 7.7 × 10⁻⁹ | 1.8 × 10⁻⁶ | 235 | 237 |
| | 350 | 0.0003 | 0.0705 | | | | |
| | 420 | 0.0006 | 0.1352 | | | | |
| | 490 | 0.0013 | 0.2862 | | | | |
| HP40 | 285 | 0.0002 | 0.0398 | 6.4 × 10⁻⁹ | 1.5 × 10⁻⁶ | 231 | 232 |
| | 355 | 0.0004 | 0.0848 | | | | |
| | 423 | 0.0008 | 0.1498 | | | | |
| | 492 | 0.0012 | 0.2775 | | | | |
| Ti2AlC | 342 | 0.0002 | 0.0166 | 1.0 × 10⁻⁹ | 2.4 × 10⁻⁷ | 230 | 229 |
| | 445 | 0.0003 | 0.0359 | | | | |
| | 537 | 0.0004 | 0.0557 | | | | |
| | 628 | 0.0005 | 0.0794 | | | | |
| Mg—SiC | 70 | 0.0001 | 0.0005 | 9.9 × 10⁻⁹ | 6.3 × 10⁻⁷ | 63 | 59 |
| | 140 | 0.0004 | 0.0045 | | | | |
| | 210 | 0.0006 | 0.0168 | | | | |
| | 280 | 0.0009 | 0.0459 | | | | |
| Mg-312 | 159 | 0.0001 | 0.0178 | 1.8 × 10⁻⁸ | 1.7 × 10⁻⁶ | 94 | 93 |
| (Random) | 186 | 0.0002 | 0.0304 | | | | |
| | 213 | 0.0003 | 0.0457 | | | | |
| | 241 | 0.0005 | 0.0671 | | | | |
| Mg-312 | 159 | 0.0003 | 0.0179 | 1.7 × 10⁻⁸ | 1.7 × 10⁻⁶ | 102 | 99 |
| (Oriented) | 188 | 0.0004 | 0.0274 | | | | |
| | 215 | 0.0006 | 0.0432 | | | | |
| | 243 | 0.0008 | 0.066 | | | | |
| Ti₃SiC₂ | 307 | 0.0001 | 0.0208 | 2.8 × 10⁻⁹ | 5.2 × 10⁻⁷ | 193 | 192 |
| | 417 | 0.0003 | 0.0516 | | | | |
| | 514 | 0.0006 | 0.0988 | | | | |
| | 623 | 0.0009 | 0.1732 | | | | |

According to Eqs. 4-6, plots of W_{d} vs., ε_{NL} vs. σ² and W_{d} vs. ε_{NL} should all yield straight lines, as observed in FIGS. 14a-f, with the exception of Mg—SiC (see discussion below). The lowest correlation coefficient of all other composites, R², value is >0.95. Table 4 lists the physical constants used herein and the threshold stresses, σₜ, obtained from the W_{d} vs. σ² plots (FIGS. 14a and d). Also, based on the results shown in FIGS. 14a-f, the model presented herein, and the constants listed in Table 7 (below), the values of 2α, Ω/b, Nₖ, 2β_{av,c}, 2βₐᵥ, ρᵣₑᵥ and ε_{IKB} were calculated; note that 2α in Table 7 is calculated from the σₜ values and Eq. 1; ε_{NL} values are those directly measured by the extensometer that was attached to the surface of the samples.

Table 7, below, provides a list of the experimentally measured σₜ values obtained from the W_{d} vs. σ² plots (FIGS. 14a and d) and 2α values calculated from the σₜ values in column 1 and Eq. 1. Also listed are calculated values of Ω/b obtained from Eqs. 4&5 and 6 (columns 4 and 5, respectively), Nₖ, 2β_{av,c}, ε_{IKB} calculated from the third term of Eq. 4 and ε_{NL} measured directly by the extensometer. The 2βₐᵥ, and ρᵣₑᵥ values at the stress levels listed in the last column are also included. For all cases, b=3.0 Å, M=3, w=5b, k₁=2; G and v of the Ti₂AlC—Mg, Mg-312 and Mg—SiC composites were assumed to be 50 GPa and 0.26, 58 GPa and 0.26, and 70 GPa and 0.22, obtained assuming that rule-of-mixtures' lower bound in particulate composites is valid for all the composites tested herein. Those of Ti₂AlC, Ti₃SiC₂, SiC, and Mg are 118 GPa and 0.2, 144 GPa and 0.2, and 192 and 0.142, and 19 GPa and 0.35 respectively.

TABLE 7

| | | | Ω/b | Ω/b | | | | | | | |
|---|---|---|---|---|---|---|---|---|---|---|---|
| | σₜ | 2α | (MPa) | (MPa) | Nₖ | 2β_{av, c} | 2βₐᵥ | ρᵣₑᵥ | ε_{IKB} | ε_{NL} | σ |
| | (MPa) | (μm) | Eqs. 4&5 | Eq. 6 | (m⁻³) | (μm) | (μm) | (m⁻²) | calculated | measured | (MPa) |
| MI-P | 162 | 3 | 38.4 | 38.2 | 4.7 × 10¹⁷ | 0.29 | 0.79 | 1.5 × 10¹⁴ | 0.0025 | 0.0027 | 445 |
| MI-R | 198 | 2 | 37.5 | 37.2 | 1.1 × 10¹⁸ | 0.23 | 0.56 | 1.6 × 10¹⁴ | 0.0018 | 0.0021 | 475 |
| MI-N | 198 | 2 | 37.5 | 37.3 | 9.7 × 10¹⁷ | 0.23 | 0.48 | 1.3 × 10¹⁴ | 0.0011 | 0.0011 | 405 |
| HP50 | 225 | 2 | 39.2 | 39.5 | 1.8 × 10¹⁸ | 0.20 | 0.45 | 1.7 × 10¹⁴ | 0.0015 | 0.0013 | 490 |
| HP40 | 219 | 2 | 38.5 | 38.7 | 1.3 × 10¹⁸ | 0.21 | 0.48 | 1.3 × 10¹⁴ | 0.0012 | 0.0012 | 492 |
| Ti₂AlC | 226 | 8 | 38.3 | 38.2 | 7.1 × 10¹⁵ | 0.48 | 0.95 | 8.8 × 10¹² | 0.0003 | 0.0002 | 445 |
| Random | | | | | | | | | | | |
| Mg—SiC | 99 | 18 | 10.5 | 9.8 | 4.1 × 10¹⁵ | 0.65 | 1.85 | 1.7 × 10¹³ | 0.0007 | 0.0009 | 280 |
| Mg-312 | 128 | 7 | 15.7 | 15.5 | 8.7 × 10¹⁶ | 0.41 | 0.77 | 5.5 × 10¹³ | 0.0007 | 0.0005 | 241 |
| Random | | | | | | | | | | | |
| Mg-312 | 134 | 7 | 16.9 | 16.6 | 1.0 × 10¹⁷ | 0.40 | 0.71 | 5.7 × 10¹³ | 0.0007 | 0.0008 | 243 |
| Oriented | | | | | | | | | | | |
| Ti₃SiC₂ | 284 | 10 | 32.1 | 31.9 | 3.4 × 10¹⁶ | 0.47 | 0.68 | 2.8 × 10¹³ | 0.0003 | 0.0003 | 417 |
| Random | | | | | | | | | | | |

### Kinking Nonlinear Elasticity

The MI-P composite has exceptional damping capability; at 450 MPa, its W_{d} is ˜0.6 MJ/m³, a value that surpasses the previous record of 0.42 MJ/m³ at 450 MPa reported for MI-R composite. When the W_{d} results of MI-P composite are compared with those of fully dense single-phase Ti₂AlC with comparable grain size—the former are higher by at least one order of magnitude. Also when the W_{d} results of MI-P composite are compared with those of fully dense and 10 vol. % porous Ti₂AlC with larger grains, W_{d} of the composites fabricated herein are larger by at least a factor of 2.

Additionally, the response of the Mg—Ti₂AlC composites depends on the orientation of the basal planes relative to the loading direction (FIG. 7a-c) in a way that is intuitive and consistent with kinking phenomena. As expected, at all stresses, the W_{d} of the MI-P sample is roughly double that of MI-N sample (FIG. 14a); those associated with MI-R sample fall in between. The simplest explanation is that when the grains are oriented edge-on, they are more prone to kink. The presence of a “relatively softer”, but nanocrystalline-Mg (nc-Mg) phase in between these grains, very similar to pores, gives these grains “room” to kink. Unlike the pores that are present in the MAX phase material alone, however, the nc-Mg matrix here allows the composite to be loaded to much higher stresses. At 0.6 MJ/m³, W_{d} for MI-P sample is believed to be a new record for crystalline solids at stresses of the order of 450 MPa. The influence of Mg-matrix is the opposite of the small equiaxed grains in Ti₂Al(C_{0.5},N_{0.5}) solid solutions wherein the “hard” small grains constrain the majority grains from kinking. The main effect of porosity in the MAX phases is to reduce σₜ, that in turn promotes kinking because kinking is a form of buckling, which is more likely to occur in a porous solid than in a denser one. The presence of pores, however, would restrict applications to lower stresses and hence smaller loops. The fact that the HP40 porous sample can dissipate more energy at low stress levels (<420 MPa) than fully dense HP50 sample is in line with previous results (A. G. Zhou, M. W. Barsoum, S. Basu, S. R. Kalidindi, T. El-Raghy, Acta Mater. 2006, 54, 1631, incorporated herein by reference). This observation, together with the fact that the MI-P composites produce the largest loops yet, is compelling evidence that what is observed is due to IKBs because it essentially eliminates any deformation mechanism that scales with the volume of the material, and/or depends on shear alone such as dislocation pileups. Said otherwise, had dislocation pileups been responsible for the loops, the values of W_{d} would have been expected to be highest for the random, fully dense, microstructure.

In contrast to Mg—Ti₂AlC samples, the W_{d} vs. σ² plots of the randomly oriented Mg-312 composite and that of the oriented Mg-312 sample (FIG. 14d) seem to be, within the experimental scatter, identical, although X-ray diffraction results (Table 4, supra) showed that apparently Ti₃SiC₂ grains have adopted a preferred orientation. Although not intending to be bound by any particular theory, the reason for this state of affairs can be related to the equiaxed morphology of the Ti₃SiC₂ grains that are relatively less amenable to kinking compared to plate-like grains of Ti₂AlC. This is best manifested by comparing the OM micrographs of FIG. 3. The results shown in Table 7 (supra) are important for several reasons. The fact that the values of Ω/b calculated from Eqs. 4& 5 and Eq. 6, are almost identical in all cases is strong evidence that the micromechanism that is causing the strain nonlinearity is the same as that resulting in W_{d}. Hence, for example, we can exclude microcracking as a possible mechanism for W_{d}.

All the Ω/b values obtained here from Ti₂AlC and Mg—Ti₂AlC composites are substantially comparable, but larger than those reported for Ti₂AlC in A. G. Zhou, et al.; A. G. Zhou & M. W. Barsoum, Submitted for Publication 2009 to Acta Materialia; and Zhou A G, Barsoum M W, Basu S, Kalidindi S R, El-Raghy T. Incipient and Regular Kink Bands in Dense and Porous Ti2AlC. Acta Mater. 2006; 54:1631, each incorporated herein by reference. The reasons(s) for this discrepancy are not entirely clear but could be due to: i) the different sources of materials used in this work, ii) the different processing techniques utilized herein and iii) the choice of k₁ assumed to be 2 throughout the present example. It is imperative to note that based on the assumption k₁=3, if true, our model predicts Ω/b values of 24±1 MPa that is perfectly in line with our previous works on Ti₂AlC in A. G. Zhou, et al.; A. G. Zhou & M. W. Barsoum, Submitted for Publication 2009 to Acta Materialia; and Zhou A G, Barsoum M W, Basu S, Kalidindi S R, El-Raghy T. Incipient and Regular Kink Bands in Dense and Porous Ti2AlC. Acta Mater. 2006; 54:1631, each incorporated herein by reference. Because the origin of the discrepancies reported above is not entirely clear at this point, it is possible to continue assuming k₁=2 throughout this example for consistency with previous works. What is somewhat surprising, however, is that k₁ regardless of our assumptions and its true value, is constant and not a function of orientation because obviously all the Mg—Ti₂AlC composites with different orientation of the basal planes relative to the loading direction yield almost equal Ω/b values.

When the Ω/b values for Mg-312 composites (1611 MPa) in Table 7 are compared with those of Ti₃SiC₂ (32 MPa obtained here and 30 MPa reported in A. G. Zhou & M. W. Barsoum, Submitted for Publication 2009 to Acta Materialia) and Mg (3 MPa), it is implied that Ω/b values for Mg-312 composites are very close to the average Ω/b values for its constituents, being Mg and Ti₃SiC₂; one possible rationale is that both constituents kink equally. Note that, i) the 2α values calculated from the experimentally measured σ^{t} values (Table 4) for Ti₃SiC₂ and Mg-312 composites (10 and 7 μm) seem to be consistent, at the very least, with the 8±2 μm experimentally measured 2α of the Ti₃SiC₂ grains (FIG. 3b); ii) also the intergranular spacing between the Ti₃SiC₂ grains in the Mg-312 composite measured from its scanning electron microscope images (not shown) varies within the range of 5-15 μm.

On the other hand, the Ω/b values for Mg—SiC composite (10 MPa) are the lowest values obtained pursuant to the present invention. Since SiC is not a KNE solid, the strain nonlinearity and W_{d} values observed herein should, in principle, be associated with Mg matrix of the Mg—SiC composite alone. However, this value seems to be higher than the 3-4 MPa values reported in previous studies concerning the Mg—SiC composite. The reason(s) for this discrepancy is not entirely clear at this point but it could be due to the presence of impurities and oxides such as MgO (formed during hot pressing and detected by X-ray diffraction) within the Mg matrix that could increase the Ω/b values. Just like the hexagonal metals investigated in A. G. Zhou, M. W. Barsoum, METALLURGICAL AND MATERIALS TRANSACTIONS A, In Print and A. G. Zhou, S. Basu, M. W. Barsoum, Acta Materialia 2008, 56, 60 (each incorporated herein by reference), the results of Mg—SiC composite do not fall on straight lines (note R² values in FIGS. 14d-f) and one can readily observe deviation from linearity in Mg—SiC composite because it is believed that Mg is the only constituent that is kinking in Mg—SiC composites.

At≈1.3×10¹⁴ to 1.7×10¹⁴ m⁻², the values of ρᵣₑᵥ at the maximum stresses in all Mg—Ti₂AlC composites tested here fall in a very narrow range despite the large differences in size and shape of the original loops from which these values were extracted. ρᵣₑᵥ is not the dislocation density in the sample when the load is removed, but rather the one due solely to the IKBs, i.e., ρᵣₑᵥ given by Eq. 8. More importantly, the values of ρᵣₑᵥ at the maximum (and comparable) stress levels given in Table 7, supra, for Mg—SiC and Mg-312 composites fall in the very narrow range of 1.7×10¹³ to 5.7×10¹³ m⁻². More specifically, the values of ρᵣₑᵥ fall in this narrow range despite the fact that: i) the maximum applied stresses vary in some cases by a factor of 2 (e.g., in HP50 that was compressed up to 610 MPa, at which stress level ρᵣₑᵥ was calculated to be 2.1×10¹⁴ m⁻²); ii) the N_{K} values vary by ˜3 order of magnitude, iii) the variations in σₜ and 2α.

It has also been reported elsewhere (A. G. Z. M. W. Barsoum, Submitted for Publication 2009 to Acta Materialia) that in Ti₃AlC₂, Ti₂AlC, Ti₃Al(C_{0.5},N_{0.5})₂ and Ti₂Al(C_{0.5},N_{0.5}) compounds—although Nₖ and the maximum applied stresses vary widely—ρᵣₑᵥ vary by less than an order of magnitude (1×10¹³ to 9×10¹³ m⁻²); similarly in Mg wherein Nₖ variation was over almost 4 orders of magnitude, the reversible dislocation density, ρᵣₑᵥ, varies by a factor of only 20. Thus, the results of the present investigation unambiguously suggests that ρᵣₑᵥ must be a strong function of stress than microstructure and the present observations strongly suggest that an equilibrium ρᵣₑᵥ exists to which all systems migrate, regardless of their composition and microstructures.

More intriguingly, the excellent agreement between the measured ε_{NL} values and those calculated from the second term in Eq. 5 (ε_{IKB}) of our KNE model in all materials tested herein is noteworthy, and is a strong notion of our model's validity.

Lastly, the choice of the value of w=5b, needs to be addressed. The minimum value of w could be w=b that seems to be unreasonable because it results in 2α values in the order of ≈20 μm using Eq. 1 for the Mg—Ti₂AlC composites and ≈35 μm in Mg—Ti₃SiC₂ composites that are inconsistent with micrographs of FIG. 3; note that experimentally measured 2α, which is the thickness of the Ti₂AlC and Ti₃SiC₂ grains along the c-axis, is ˜5±3 μm and 8±2 μm. On the other extreme, assuming w=20b, yields 2α values 1 μm for the Mg—Ti₂AlC composites and ≈2 μm in Mg—Ti₃SiC₂ composites, which is again not consistent with the micrographs shown in FIG. 3. Assuming w=5b, implies the width of the average Ti₂AlC and Ti₃SiC₂ grains to be ≈3 μm and 7 μm, respectively, and in reasonable agreement with experimentally measured 2α values (5±3 μm and 8±2 μm). These are significant results and strongly suggest that the microscale model presented herein is correct, but more convincingly suggest that the microscale model presented herein functions properly regardless of the material system under investigation, the microstructure and the range of stresses applied.

### Vickers Microhardness (V_{H})

At ˜2 and 1.5 GPa, the V_{H} obtained herein for HP and MI composites are again remarkably high for a 50 vol. % Mg composite. The hardness enhancement in HP sample compared to its MI counterpart can be attributed to the smaller nc-Mg matrix in the former. The MI-N orientation is also 25% harder than its counterpart, MI-P. Since both samples were obtained from the same billet, without intending to be bound by any particular theory, it is fair to conclude that the orientation effect of the basal planes is responsible for the difference. Due to the larger presence of basal planes—on the indentation surface—the hardness is noticeably higher because the indenter is facing more Ti₂AlC grains than Mg in MI-P and more Mg than Ti₂AlC in MI-N; this was corroborated by image analysis on MI-P and MI-N samples, wherein the former showed a larger presence of Ti₂AlC grains by 7±1%.

Another possible factor is that the MAX phases are also intrinsically anisotropic when it comes to their hardness. It was shown by B. J. Kooi, R. J. Poppen, N. J. M. Carvalho, D. J. T. M., M. W. Barsoum, Acta Materialia 2003, 51, 2859 (incorporated herein by reference) that, using orientation image microscopy and a Berkovich nanoindenter, lower hardness values were obtained in Ti₃SiC₂ when the indenter was perpendicular to the basal planes, i.e., when loaded along the c-direction. Although the present results show that higher V_{H} was obtained when loaded perpendicular to the basal planes, it is noted that, i) Kooi et al. performed their nano-indentations into individual Ti₃SiC₂ grains with their basal planes either oriented parallel or perpendicular with respect to the surface, while our V_{H} values are those obtained from a Mg—Ti₂AlC composite that constitutes polycrystalline Ti₂AlC grains and Mg-nanograins in the matrix, and ii) it is believed that there are no results on plastic anisotropy of Ti₂AlC in terms of hardness to be compared with the present findings.

The V_{H} values of the nc Mg—Ti₂AlC composites tested herein are comparable to those of Mg-matrix composites in which the reinforcing phase is significantly harder. For example, at 2 GPa our results are comparable to those of the Mg—SiC samples tested here (FIG. 4), and Mg—TiC composites, with 56 vol. % TiC previously reported, and even higher than Mg-312 samples (FIG. 4) tested here and greater than ˜1.1 GPa values reported in Mg—TiC composites fabricated by powder metallurgy. There are also other reports in the literature for Mg alloy matrix composites such as AZ91D reinforced with TiC with V_{H} values at 1 GPa (Q. C. Jiang, H. Y. Wang, J. G. Wang, Q. F. Guan, C. L. Xu, Materials Letters 2003, 57, 2580, incorporated herein by reference), all surpassed by values obtained here. In all cases, a significant hardness difference between SiC (V_{H} ˜28 GPa), TiC (V_{H} ˜35 GPa) and Ti₃SiC₂ on the one hand, and Ti₂AlC, on the other, is compensated by the nano-crystalline nature of the Mg-matrix.

Like most MAX phases, the hardness values of monolithic Ti₂AlC are initially high, decrease with increasing load, and asymptote at higher loads. The inventive composites' hardness values are not a function of load and fall in between those of pure Mg and monolithic Ti₂AlC. Like the vast majority of MAX phases, no cracks are observed to emanate from the corners of the Vickers indentations of the composite samples. This damage tolerance is a hallmark of the MAX phases and results from the activation of basal slip which allows the material to absorb energy locally by various energy absorbing mechanisms such as microcracking, delamination, grain buckling and grain pull-out. The plastic deformation of the Mg matrix must also play an important role. The desirability of such high damage tolerance in potential applications is very high.

In sum, the results obtained herein may aid in designing solids with ultrahigh damping capabilities. Depending on the application and the stress levels required during service, different MAX-Mg composites can be used. For relatively high stress applications, MAX-Mg composites with preferred orientation of basal planes would yield ultrahigh W_{d} values. Regardless of their microstructure, the so-called “MAXMET”s fabricated in accordance with the present invention are KNE solids and they have shown the formation of fully reversible hysteretic stress-strain loops under cyclic compression. The microscale model developed herein to analyze and explain kinking nonlinear elasticity in KNE solids is in agreement with the experimental results obtained in the present composites and their monolithic counterparts. The Ω/b values obtained here for the composites are a function of their constituents and whether or not they might kink, e.g., the nc-Mg matrix of the Mg—Ti₂AlC composites seems to be not kinking because of the higher Ω/b values obtained here. On the contrary, because the Mg matrix of the Mg-312 composites are not at the nanoscale and are prone to kinking, the Ω/b values obtained are considerably less than that of Mg—Ti₂AlC system, and seems to be the average of Ω/b values of Mg and Ti₃SiC₂. The Mg—SiC, in which only the Mg matrix is supposedly the kinking constituent, showed the lowest Ω/b values. Although different composites and MAX phases with different microstructures were examined, it was noteworthy to observe that based on the present KNE model, the ρᵣₑᵥ values obtained here fall in a very narrow range, implying the presence of an equilibrium state to which all the systems migrate.

### Example 6

### Thermal Stability of Magnesium Nanograins

The preceding disclosure includes the processing and microstructural characterization of 50 vol. % Ti₂AlC Mg matrix composites fabricated by pressureless melt infiltration, in which the Mg grains were 20-40 nm in size. The Mg nanostructures are exceptionally stable. For example, it was found that annealing in argon, Ar, gas for 6 h at 550° C. did not alter the size of the Mg grains.

One objective of the present study was to explore the stability limits of the nano-sized Mg grains. A secondary goal was to understand, quantify, and relate the melting point reductions to the size of the Mg nano-particles. To these ends and others, three sets of composite samples were fabricated. The first was formed by the spontaneous melt infiltration, MI (the process of which is described herein), of a porous Ti₂AlC preform at 750° C. The second set of samples was fabricated by hot pressing, HP, the starting Ti₂AlC and Mg powders at 750° C. while a load, corresponding to a stress of ˜45 MPa, was applied. X-ray diffraction, XRD, established that the Mg grains in both cases were ˜35±15 nm in diameter. Transmission electron microscope, TEM, images confirmed the nano-scale of the grains. A third sample group consisting of Mg-50 vol. % Ti₃SiC₂ composites was also fabricated by MI. With respect to the third group, the Mg grain size was not nanoscale. The behavior of pure Mg was also considered. In all cases, the Mg was 99.8% pure (Alfa Aesar, Ward Hill, Mass.). The −325 mesh, and the Ti₂AlC and Ti₃SiC₂ powders were commercially obtained (3ONE2, Voorhees, N.J.).

Differential scanning calorimetry analysis, DSC, was carried out on bulk samples in a simultaneous TGA/DSC unit (Netzsch STA 449C Jupiter, Selb, Germany) in ultra high pure Ar, in sintered Al₂O₃ crucibles. The temperature was cycled three times from room temperature to 973 K and back to 373 K, at 10 K/min. TEM foils were prepared by a conventional TEM sample preparation process and characterization was performed using a field emission TEM (JEOL JEM-2010F) operating at 200 kV. HRTEM was carried out in a JEOL JEM-2100 unit operating at 200 kV.

The DSC results (FIGS. 12a and b) were unambiguous: repeated melting of the composites did not lead to the coarsening of the Mg grains. Table 8, below, summarizes the onsets of melting, Tₘ, and solidification, Tₛ, of the four samples tested.

TABLE 8

| | | | rₐᵥ | σₛₗ | ΔH_{f} (kJ/mol) | ΔHₛ (kJ/mol) |
|---|---|---|---|---|---|---|
| | Tₘ (° C.) | Tₛ (° C.) | nm | (mJ/m²) | From DSC | from DSC |
| Pure Mg | 646 ± 1* | 645 ± 1 | — | 90 | 8.5 ± 0.2** | 8.6 ± 0.1 |
| MI-Ti₂AlC | 601 ± 2 | 633 ± 1 | 17‡ | 327 ± 60 | 8.6 ± 0.1 | 8.3 ± 0.4 |
| MI-Ti₂AlC | 603 ± 1 | 635 ± 1 | | — | 5.2 ± 0.1 | 5.1 ± 0.3 |
| H₂ Annealed | | | | | | |
| HP-Ti₂AlC | 588 ± 1 | 625 ± 1 | 13‡‡ | 327 ± 60 | 5.7 ± 0.3 | 5.4 ± 0.8 |
| MI-Ti₃SiC₂ | 638 ± 1 | 640 ± 1 | | — | 6.9 ± 0.1 | 6.8 ± 0.4 |

‡From XRD line broadening
‡‡Calculated assuming σₛₗ = 327 mJ/m²
*650° C. reported in [1]
**8.5 kJ/mol reported in [1]
[1] E. Brandes GBB, c. Smithells. Smithells Metals Reference Book: Oxford; Boston: Butterworth-Heinemann, 1998.

For the data depicted in Table 8, the rₐᵥ of the Mg grains in the MI-sample was assumed to be 17±8 nm. The value of σₛₗ was then used to estimate the average particle size for the HP sample. The standard deviation reported for the ΔHᵢ values are with respect to the three cycles. The actual uncertainty in the ΔHᵢ values, reflected in the differences between runs, is significantly larger since the exact amount of Mg—assumed to be 50 vol. %—in the composite is not known.

At 645° C., the melting point of the 99.8% pure Mg compared favorably with the value of 649° C. reported in E. Brandes, G. B. B., c. Smithells, Smithells Metals Reference Book, Oxford; Boston: Butterworth-Heinemann: 1998, and in ASM Handbooks Online, In ASM International: 2008 each incorporated herein by reference. The onset of solidification was also close to that of melting. At 638° C., the onset of melting in the MI—Ti₃SiC₂ was slightly reduced as compared with pure Mg, a reduction that probably partially reflects the large Ti₃SiC₂/Mg interfacial area and/or the fact that the Mg is no longer pure. The reductions in MP, as compared to the bulk Mg, for the MI- and HP—Ti₂AlC samples were 45 K and 58 K, respectively. The respective onsets of solidification were also suppressed by 12 K and 20 K relative to pure Mg. Most surprisingly, heating the samples to 700° C. three times clearly did not affect these values. The reproducibility is noteworthy. Clearly, the microstructures formed during the fabrication of these composites are extremely stable.

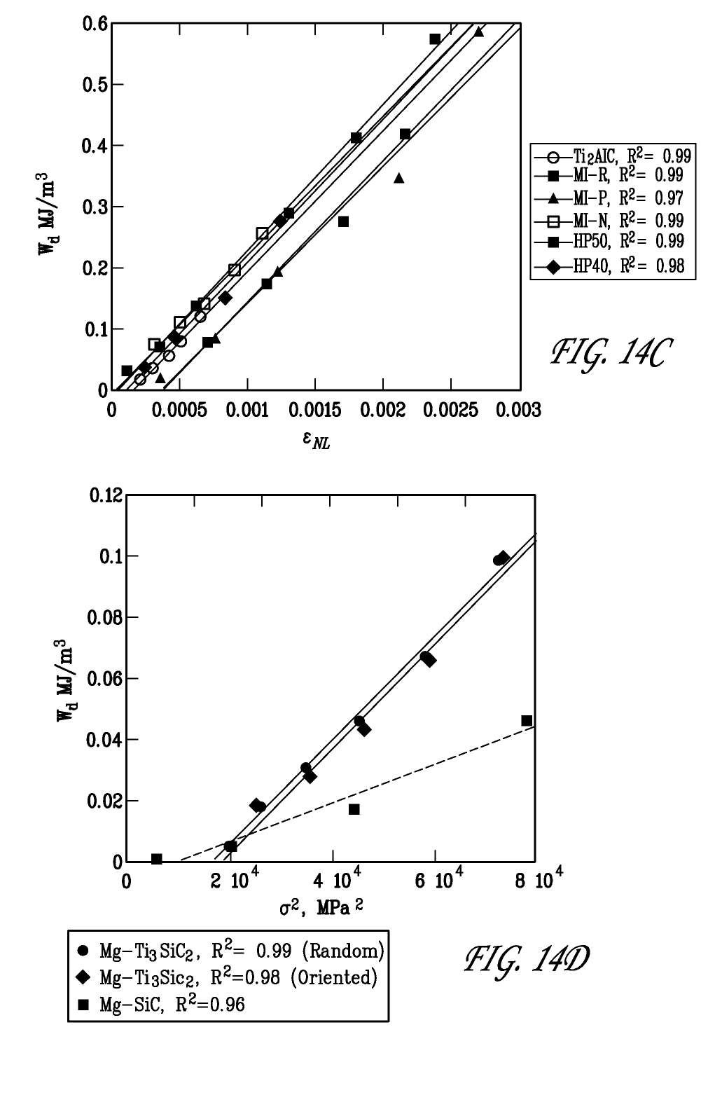

Not wishing to be bound by any particular theory, it is possible to conclude that a sheath or skin that did not melt prevented the Mg grains from coarsening. The simplest assumption is that the nano-grains are encased in a very thin oxide jacket. Indeed, the presence of such oxides was confirmed by both XRD and neutron spectroscopy. As reported elsewhere, XRD spectra of the composites included small peaks that could be indexed to MgO (Amini, S.; Ni, C.; Barsoum, M. W. Composites Science and Technology 2009, 69, 414-420, incorporated herein by reference). A filter difference spectrometer (FDS) at Los Alamos National Laboratory was used to obtain a reference vibrational spectrum (curve “A” in FIG. 13) of a MI-Ti₂AlC sample. The sample was then loaded in a stainless steel crucible and heated to 250° C. for 20 h. The crucible was evacuated and connected to a hydrogen cylinder supplying a constant pressure of H₂ of 68 bar. After cooling to room temperature and releasing the pressure, a second neutron vibrational spectrum (curve “B” in FIG. 13) was collected. For both FDS measurements, the sample was placed in a sealed cylindrical aluminum can under a He atmosphere. Data were collected at 10 K.

Closer examination of the reference spectrum (FIG. 13) shows a number of vibrational modes consistent with the presence of rutile and anatase (Mikami, M.; Nakamura, S.; Kitao, O.; Arakawa, H. Physical Review B (Condensed Matter and Materials Physics) 2002, 66, (15), 155213-1; Traylor, J. G.; Smith, H. G.; Nicklow, R. M.; Wilkinson, M. K Physical Review B (Solid State) 1971, 3, (10), 3457-72; each incorporated herein by reference). This was further confirmed by the weakening or disappearance of some of these modes in the vibrational spectrum after the H₂ annealing. The remaining modes are tentatively ascribed to Ti₂AlC since the intensities of the modes associated with Ti₂AlC remained unchanged after the H₂ anneal. It follows that much of the H₂ supplied to the sample was consumed in the reduction of the oxides—a reduction that may not have been complete at the time heating was stopped because some intensity remains in the vibrational spectrum where the lattice modes of TiO₂ appear. As a further testament of the stability of the microstructure, the major effect of the H₂ reduction was to skew the DSC baseline for reasons that are not clear. However, for the most part, the reductions in melting points and solidification temperatures were not that different to those of the MI-Ti₂AlC sample.

Attention is now turned to the reduction in melting points. The phenomenon of particle-size-dependent Tₘ depression has received significant attention since the early work of Takagi in 1954, where the melting points of thin (10-1000 Å) metallic films were found to be size-dependent. The melting point depression depends on several factors including the substance explored and the melting conditions. For example, in 1 nm Au particles, the Tₘ depression was 500 K. For Al particles, with radii, r, of 10 nm, however, it could be relatively small, e.g., ˜13 K. Allen et al. showed that submicron crystallites of Pb, Sn, In and Bi melted in situ in a TEM exhibited melting points that decreased with decreasing particle size and a near-linear relationship was observed for Tₘ as a function of r. The same is true of free-standing Sn and Pb nanoparticles and in nanowires and nanofilms, where Tₘ decreased with decreasing size. The phenomenon is not restricted to metallic particle. For example, CdS also exhibits a large depression in Tₘ with decreasing size.

The thermal behavior of nanoparticles differ from that of bulk samples because of the increase in surface-to-volume ratio and a corresponding increase in the proportion of loosely bound surface atoms that have low coordination numbers (Sun, J.; Pantoya, M. L.; Simon, S. L. Thermochimica Acta 2006, 444, (2), 117-127, incorporated herein by reference). Classic thermodynamics predict that

$${T}_{m} ( r ) = Tm ( ∞ ) - \frac{2 {T}_{m} ( ∞ ) {σ}_{sl}}{Δ {H}_{f} ( ∞ ) {V}_{m} r} \qquad ( 1 )$$

where Tₘ (∞), ΔH_{f} (∞) and Vₘ are, respectively, the melting temperature, latent molar heat of fusion, and molar volumes of bulk Mg; r is the radius of a spherical particle with melting point Tₘ (r); σₛₗ is the solid-liquid interfacial energy. Making the following assumptions for the MI-Ti₂AlC sample: ΔT=45 K, ΔH_{f}=8.6 kJ/mole and r=17 nm, σₛ₁ is calculated to be 255 mJ/m². For the HP samples, with a ΔT=58 K, and the same values for the other parameters, yields σₛₗ=327 mJ/m². Given that the experiments were concerned with the same system, it is reasonable to assume the same value of σₛₗ. The fact that they are not is most probably because of the uncertainty in the exact value of r and Mg content; and while XRD line broadening yields the same average r value for both composites, the matrix in the HP samples in the TEM appeared finer compared to MI sample (FIGS. 9c and d). More importantly, the melting onset for the HP-samples occurs at a lower temperature. If one assumes σₛₗ for the HP samples to be 252 mJ/m², then r for that sample would be 13.2 nm, which is not unreasonable. This is independently, but indirectly, corroborated by the fact that the ultimate compressive stresses of the HP samples were slightly higher than the MI ones. Since this was believed to be the first study on the effect of particle size on the melting of Mg nano-grains, there are no prior examples with which to compare the present results.

In the continuing quest for improved performance of materials, including lighter, stiffer and stronger ones, many approaches have been attempted; one of the more successful being composite materials. More recently, much emphasis has been given to nano-scaled solids for structural applications and while the advantages of nano-structured solids, in some applications, are clear, making the latter economically and on an industrial scale has been more of a challenge. Typically, nano-sized powders—that ideally have to remain non-agglomerated and mono-dispersed—are first synthesized and then consolidated.

To maintain the nano-scale morphology during consolidation of metals, in general, and low melting point metals in particular, is non-trivial. Even when such microstructures are fabricated, their use is typically limited to ambient or near ambient temperatures in order to prevent grain growth.

Given these constraints and hurdles, the fact that it is possible to spontaneously infiltrate a ceramic preform, and obtain a superbly machinable—like all other MAX phases such as Ti₂AlC—nano-structured composite, with a strength of >700 MPa, a stiffness of the order of 70 GPa, density of 2.87 Mg/m³, that can also dissipate 25% of the mechanical energy during each cycle, is noteworthy.

Note that since the wetting, and subsequent infiltration, are spontaneous, there should in principle, be no limits to the sizes or shapes of the Ti₂AlC perform, which in turn would allow for the production of large, near-net shape parts or components. As important, when the reasons for the formation of the Mg nano-grains are better understood, and if they can then be implemented without Ti₂AlC and/or with much lower concentrations of the latter, then this work may lead to the casting of large, nano-grained, Mg ingots economically and on an industrial scale with not much more infrastructure than what is used in the casting of Mg today.

Mg is a promising hydrogen storage material due to its high storage capacity (˜7.66 wt. %). However, the high absorption and desorption temperature (400° C.) and poor kinetics prevent its practical applications. Huge efforts have been devoted to improve its hydrogen storage properties by forming Mg nano-composites by mechanical alloying because it is well established that the hydrogen storage capacity, and the kinetics of hydrogen absorption/desorption of Mg are strongly linked to its microstructure showing that when the Mg morphology is on the nanoscale, the storage kinetics are faster. It has also been shown that by forming nano-composites of Mg with intermetallic compounds through mechanical alloying, the desorption temperature of Mg is lowered and the desorption kinetics improved. This is due to the large amount of interphase boundaries, and short hydrogen diffusion length. Thus, understanding of the factors that affect stability of nanostructured materials is critical to identifying the best strategies for future technology development. Thus, the thermal stability of the microstructure obtained herein, is an advantage that other nano-Mg powders developed for hydrogen storage—typically fabricated by mechanical alloying—do not posses because the high degree of internal stored energy in the latter invariably leads to recrystallization with partial or total annihilation of the nanocrystalline structure. Such knowledge could also be used to thermally spray such nano-grained powders. The latter could, in turn, become an important, high-performance, safe and cost-effective hydrogen storage medium.

### Example 7

### Exemplary Hot Pressing Technique

Starting powders of Ti₂AlC (−325 mesh, 3-ONE-2, Voorhees, N.J.) and Mg (−325 mesh, 99.8% pure, Alfa Aesar, Ward Hill, Mass.) were ball-milled for 12 h and dried in a mechanical vacuum furnace at 150° C. for 24 h. The dried powder mixtures were poured and wrapped in graphite foil, that, in turn, were placed in a graphite die and hot pressed in a graphite-heated vacuum-atmosphere hot press, HP, (Series 3600, Centorr Vacuum Industries, Somerville, Mass.), heated at 10° C./min to 750° C. and held at the target temperature for 1 h, after which the HP was turned off and the samples were furnace cooled. A load, corresponding to a stress of 45 MPa, was applied when the temperature reached 500° C. and maintained thereafter. The samples were removed from the dies and the graphite foil was removed.

### Example 8

### Exemplary Melt Infiltration Technique

Approximately 50 vol. % porous preforms in the form of rectangular bars (1.2×1.2×70 cm³) or cylinders (40 mm in diameter and 40 mm or 70 mm high) were fabricated by cold pressing Ti₂AlC powder (−325 mesh, 3-ONE-2, Voorhees, N.J.) together with 1 wt. % polyvinyl alcohol as a binder at 45 MPa. Two microstructures were fabricated, random and oriented. The former were made by pouring, and cold pressing the Ti₂AlC-binder mixture into a steel die. To fabricate the latter, the Ti₂AlC-binder mixture was first poured into the die and manually vibrated for 15 minutes in an attempt to orient the flaky Ti₂AlC powders perpendicular to the pressing direction. The preforms' densities were calculated by dividing their weight by their volume because they were regularly shaped. For consistency, only those preforms that were 50±1% dense were used for the infiltration process. The performs were then placed in a graphite-heated vacuum furnace and heated at 5° C./min to 900° C. held at the target temperature for 5 h, after which the furnace was turned off and the preforms were furnace cooled. More recent work showed that this step is not necessary and can be eliminated.

To carry out the infiltration step, pure Mg chunks (99.8% pure, Alfa Aesar, Ward Hill, Mass.) were placed on top of the performs that, in turn, were placed in alumina, Al₂O₃, crucibles (AdValue Technology, Tucson, Ariz.). The crucibles were covered with Al₂O₃ lids and placed in the same vacuum furnace used for sintering the preforms, heated at 10° C./min to 750° C., held at that temperature for 30 min, after which the furnace was turned off and the samples were furnace cooled. It was observed that vaporized magnesium caused the Al₂O₃ lids to seal to the crucible, thereby forming a substantially closed system within the crucible that limited further oxidation of the magnesium. Therefore, forming a substantially closed system within a container in which the infiltration step is performed can provide the additional benefit of limiting oxidation of the metal component that is infiltrated into the MAX phase material. In all cases, the excess Mg surrounding the infiltrated preforms was machined off.

What is claimed:

1. A composition comprising:
a MAX phase material having the formula Mₙ₊₁AXₙ, wherein M is an early transition metal, A is an A-group element, X is one or both of C and N, and n=1-3, wherein said MAX phase material defines a plurality of pores; and,
a metal component comprising a low melting point metal, wherein said metal occupies at least some of said pores.

2. The composition according to claim 1 wherein said metal is present in said composition in an amount of about 10 to about 70% by volume.

3. The composition according to claim 1 further comprising an oxidizing agent

4. The composition according to claim 3 wherein said oxidizing agent comprises one or more of polytetrafluoroethylene and potassium perchlorate.

5. The composition according to claim 3 wherein said polytetrafluoroethylene is present in said composition in an amount of about 20 to about 60% by volume.

6. A reactive material comprising a composition according to claim 3.

7. The composition according to claim 1 wherein said metal component is Mg.

8. The composition according to claim 1 wherein said metal component is Al.

9. The composition according to claim 1 wherein the metal component is an alloy.

10. The composition according to claim 1 wherein the metal component is an alloy comprising aluminum and magnesium.

11. The composition according to claim 10 wherein said metal component is an alloy comprising 20% magnesium and 80% aluminum.

12. The composition according to claim 10 wherein said metal component is an alloy comprising 80% magnesium and 20% aluminum.

13. The composition according to claim 1 wherein the metal component is an alloy comprising magnesium.

14. The composition according to claim 1 wherein M is tantalum, hafnium, titanium, vanadium, chromium, niobium, molybdenum, or zirconum.

15. The composition according to claim 14 wherein M is titanium, tantalum, or hafnium.

16. The composition according to claim 14 wherein at least some of M comprises a second one of tantalum, hafnium, titanium, vanadium, chromium, niobium, molybdenum, or zirconum.

17. The composition according to claim 1 wherein A is aluminum, tin, silicon, phosphorous, sulfur, gallium, germanium, arsenic, cadmium, indium, thallium, or lead.

18. The composition according to claim 17 wherein A is aluminum or tin.

19. The composition according to claim 17 wherein at least some of A comprises a second one of aluminum, tin, silicon, phosphorous, sulfur, gallium, germanium, arsenic, cadmium, indium, thallium, or lead.

20. The composition according to claim 1 wherein X comprises carbon.

21. The composition according to claim 20 wherein at least some of X further comprises nitrogen.

22. The composition according to claim 1 further comprising fibers in an amount of about 5 to about 50% by volume.

23. A method comprising:
providing a porous green body comprising a particulate material having the formula Mₙ₊₁AXₙ, wherein M is an early transition metal, A is an A-group element, X one or both of C and N, and n=1-3;
infiltrating at least some of the pores of said green body with a low melting point metal, thereby providing a composite material.

24. The method according to claim 23 further comprising compacting said composite material under elevated temperatures to provide a compacted composite.

25. The method according to claim 23 further comprising hardening the low melting point metal.

26. The method according to claim 25 wherein said hardening comprises one or more of solid solution hardening, precipitation hardening, and work hardening.

27. The method according to claim 23 wherein said green body further comprises fibers.

28. The method according to claim 27 wherein at least some of said fibers comprise a woven mass.

29. The method according to claim 27 wherein said green body comprises one or more layers comprising said compound and one or more layers comprising said fibers.

30. The method according to claim 23 wherein the provision of the green body comprises forming the green body.

31. The method according to claim 30 comprising compacting a powder comprising the particulate material.

32. The method according to claim 30 further comprising orienting the particles of said particulate material prior forming said green body.

33. The method of claim 23 wherein the green body is made by reacting titania, carbon, and aluminum to form Ti₃AlC₂ and other oxides.

34. The method according to claim 33 wherein the low melting point metal is an alloy of aluminum and magnesium.

35. The method according to claim 34 wherein the low melting point metal is an alloy of 20% aluminum and 80% magnesium.

36. The method according to claim 34 wherein the low melting point metal is an alloy of 80% aluminum and 20% magnesium.

37. The method according to claim 23 wherein the pores of said green body are infiltrated with said low melting point metal by melt infiltration.

38. The method according to claim 23 wherein the pores of said green body are infiltrated with said low melting point metal by hot pressing.
